(19) United States
(12) Patent Application Publication
(10) Pub. No.: US 2025/0371430 A1
(43) Pub. Date: Dec. 4, 2025

(54) METHOD FOR TRAINING MACHINE LEARNING MODEL IN DISTRIBUTED SYSTEM AND RELATED APPARATUS

(71) Applicant: HUAWEI TECHNOLOGIES CO., LTD., Shenzhen (CN)

(72) Inventors: Lei DONG, Shanghai (CN); Hao TANG, Shanghai (CN); Liqing ZHANG, Ottawa (CA); Jianglei Ma, Ottawa (CA)

(21) Appl. No.: 19/298,406

(22) Filed: Aug. 13, 2025

Related U.S. Application Data
(63) Continuation of application No. PCT/CN2023/075920, filed on Feb. 14, 2023.

(51) Int. Cl. G06N 20/00

(52) U.S. Cl. CPC G06N 20/00

(57) ABSTRACT

This application discloses a method for training a machine learning model in a distributed system and a related apparatus. In the distributed system, an i^{th} node in a node group obtains second data based on first data and a submodel in the i^{th} node, where the first data is local data of the i^{th} node or output data of an (i−1)^{th} node in the same node group; performs gradient backpropagation based on third data, to obtain first gradient information of the i^{th} node, where the third data is output data of an (i+1)^{th} node in the same node group or local output data obtained based on the second data; receives a model parameter from at least one first node, where the first node is a node in a second node group; and updates a parameter of a local submodel based on the model parameter.

### CROSS-REFERENCE TO RELATED APPLICATIONS

This application is a continuation of International Application No. PCT/CN2023/075920, filed on Feb. 14, 2023, the disclosure of which is hereby incorporated by reference in its entirety.

### TECHNICAL FIELD

The present disclosure relates to the field of machine learning and communication technologies, and in particular, to a method for training a machine learning model in a distributed system and a related apparatus.

### BACKGROUND

With continuous development of technologies related to artificial intelligence (AI)/machine learning (ML), AI/ML has important application potential in many aspects such as modeling and learning in a complex unknown environment, channel prediction, intelligent signal generation and processing, network status tracking and intelligent scheduling, and network optimization deployment. To reduce computing load of a single node, related researchers provide an idea of splitting learning, which is of positive significance in reducing communication overheads of the single node and expanding a sample size. However, when communication link quality of a serving node is poor, an overall AI model training delay increases, and consequently, learning efficiency is low.

### SUMMARY

This application provides a method for training a machine learning model in a distributed system and a related apparatus, to reduce a model training delay, and improve model training efficiency and model performance.

According to a first aspect, this application provides a method for training a machine learning model in a distributed system. The distributed system includes a plurality of node groups, each node group includes a plurality of nodes, each node includes a submodel of the machine learning model, and submodels in the plurality of nodes in a same node group are sequentially cascaded to form the machine learning model.

The method includes:

An i^{th} node in a first node group obtains second data based on first data and a submodel in the i^{th} node, where the first node group is any node group in the plurality of node groups, the i^{th} node is any node in the first node group, and the first data is local data of the i^{th} node or output data sent by an (i−1)^{th} node in the same node group.

The i^{th} node performs gradient backpropagation based on third data, to obtain first gradient information of the i^{th} node, where the third data is output data sent by an (i+1)^{th} node in the same node group or local output data.

The i^{th} node receives a model parameter sent by at least one first node, where the first node is a node in a second node group, and the second node group is a node group other than the first node group.

The i^{th} node updates a parameter of a local submodel based on the model parameter.

In this solution, a node in the distributed system may flexibly split the machine learning model based on a capability of each node, and information exchange of a cut layer in each node group can be completed in the group, without a need to perform information exchange of the cut layer with a single server node in a centralized manner. This can avoid an increase in an overall model training delay and learning performance degradation that are caused by deep channel fading of the single server node in a centralized training mode, and helps reduce a model training delay and improve model training efficiency. In addition, model parameters may be exchanged between the plurality of node groups, and each node group may update an allocated submodel by using a model parameter of another node group. This expands a dataset of each node group to an extent, and helps improve a training effect of a global model in each node group.

In a possible implementation, structure information of a submodel in the first node is the same as structure information of the submodel in the i^{th} node, or structure information of a submodel in the first node is different from structure information of the submodel in the i^{th} node.

The structure information includes one or more of the following: a network layer included in the submodel; and a layer index of the network layer that is included in the submodel and that is in the machine learning model.

In this implementation, in a unified splitting mode, the i^{th} node may receive a model parameter sent by a first node to which a same submodel is allocated. In a customized splitting mode, the i^{th} node may receive model parameters sent by first nodes to which different submodels are allocated, so that it can be ensured that a node participating in model training can receive at least a model parameter sent by at least one first node in another node group. In this way, each node group can maximize use of information of the another node group through inter-group exchange, to improve training accuracy of the machine learning model. Structure information of a submodel in each node may include a network layer in the submodel and a layer index of the network layer in the submodel. In this case, when inter-group model parameter exchange is performed, each node may determine, based on a layer index sent by another node, whether to receive a model parameter sent by the node.

In a possible implementation, nodes that store a same submodel in the plurality of node groups form a node cluster, each node cluster corresponds to a node cluster index, and the i^{th} node and the at least one first node correspond to a first node cluster index.

In this implementation, in the unified splitting mode, the at least one first node is a node that belongs to a same node cluster as the i^{th} node, and a node cluster index of the node cluster is the first node cluster index. In this case, the i^{th} node may determine, based on a node cluster index sent by a sending node, at least one first node that belongs to a same node cluster, and then receive a model parameter sent by the at least one first node, so that the parameter of the local submodel is subsequently updated by using the model parameter sent by the at least one first node.

In a possible implementation, the at least one first node includes each node in at least one second node group.

In this implementation, in the customized splitting mode, the at least one first node may include all nodes in at least one other node group. When the sending node does not indicate a network layer index of a submodel allocated to the sending node, the i^{th} node needs to receive all model parameters sent by all nodes in the at least one other node group, to ensure that information of the other node group can be fully used.

In a possible implementation, each node group corresponds to a node group index, and a node in each node group has a corresponding node index; and the method further includes:

The i^{th} node receives a node group index of the at least one second node group and a node index of a node in the at least one second node group.

The i^{th} node cascades, based on the received node group index and node index, a model parameter sent by the first node in each second node group, to obtain a parameter of each network layer of the machine learning model.

That the i^{th} node updates the parameter of the local submodel based on the model parameter includes:

The i^{th} node obtains, from the parameter of each network layer, a parameter corresponding to a first-layer index, where the first-layer index is a layer index of a network layer that is included in the submodel in the i^{th} node and that is in the machine learning model.

The i^{th} node updates the parameter of the local submodel based on the obtained parameter corresponding to the first-layer index and a parameter of a local model.

In this implementation, when the sending node does not indicate the network layer index of the submodel allocated to the sending node, the i^{th} node may cascade, based on the node group index of the second node group and node indexes of nodes in the second node group, model parameters sent by the nodes in the second node group, to obtain a parameter of each network layer of a global model in the second node group, extract, from the parameter of each network layer based on a first-layer index of a network layer allocated to the i^{th} node, a parameter of the network layer corresponding to the first-layer index, and may further perform parameter update on the stored submodel by fully using the parameter of the network layer corresponding to the first-layer index in the another node group and a local parameter of the allocated submodel.

In a possible implementation, the at least one first node is determined based on a second-layer index sent by a node in each second node group, the second-layer index is a layer index of a network layer that is included in a submodel in the node in each second node group and that is in the machine learning model, a second-layer index of the at least one first node and a first-layer index include a same layer index, and the first-layer index is a layer index of a network layer that is included in the submodel in the i^{th} node and that is in the machine learning model.

In this implementation, when the sending node indicates a second-layer index of the submodel allocated to the sending node, the i^{th} node may determine, based on the second-layer index, one or more first nodes that are in the second node group and that include a same layer index as the first-layer index, and receive the model parameter of the at least one first node. In this way, the model parameter can be received in a targeted manner. This avoids a problem of high bandwidth occupation caused by receiving all model parameters of all sending nodes in the customized splitting mode, and can save storage space of a receiving node.

In a possible implementation, that the i^{th} node updates the parameter of the local submodel based on the model parameter includes:

The i^{th} node updates the parameter of the local submodel based on the model parameter sent by the at least one first node and a parameter of a local model.

In this implementation, when the sending node indicates the second-layer index of the submodel allocated to the sending node, the i^{th} node may receive only a model parameter sent by one or more first nodes, to quickly perform parameter update on the allocated submodel by using the received model parameter and a local parameter of the allocated submodel.

In a possible implementation, that the i^{th} node receives the model parameter sent by the at least one first node includes:

The i^{th} node receives, after a first moment, the model parameter sent by the at least one first node, where the first moment is a moment at which the plurality of node groups complete one or more rounds of local training.

In this implementation, the i^{th} node receives, after all the node groups complete one or more rounds of local training, the model parameter sent by the at least one first node, to ensure that the plurality of node groups can synchronously perform inter-group parameter exchange.

According to a second aspect, this application further provides a method for training a machine learning model in a distributed system. The distributed system includes a plurality of nodes, each node includes a submodel of the machine learning model, and submodels in at least two nodes are sequentially cascaded to form the machine learning model.

The method includes:

An i^{th} node obtains fifth data based on fourth data and a submodel in the i^{th} node, where the i^{th} node is any node in the plurality of nodes, the fourth data is local data of the i^{th} node or data sent by at least one third node, and the at least one third node and the i^{th} node are different nodes.

The i^{th} node performs gradient backpropagation based on sixth data, to obtain second gradient information of the i^{th} node, where the sixth data is output data sent by at least one fourth node or local output data of the i^{th} node, and the at least one fourth node and the i^{th} node are different nodes.

In this solution, the fifth data is output data obtained after the i^{th} node performs forward propagation based on the fourth data, and the second gradient information is gradient data output after the i^{th} node performs gradient backpropagation based on the sixth data. A node in the distributed system may flexibly split the machine learning model based on a capability of each node. The i^{th} node may exchange the output data of forward propagation with the at least one third node, and may exchange the output data of backpropagation with the at least one fourth node, without a need to perform information exchange of the cut layer with a single server node in a centralized manner. This can avoid an increase in an overall model training delay and learning performance degradation that are caused by deep channel fading of the single server node in a centralized training mode, and helps reduce a model training delay and improve model training efficiency. In addition, the i^{th} node may train and update an allocated submodel by using inference data and gradient data of another node. This expands a local dataset of the node to an extent, and helps improve a training effect of a global model.

In a possible implementation, submodels in the at least one third node have same structure information, and/or submodels in the at least one fourth node have same structure information.

The structure information includes one or more of the following: a network layer included in the submodel; and a layer index of the network layer that is included in the submodel and that is in the machine learning model.

In this implementation, the plurality of nodes may split the machine learning model in a unified splitting mode. For example, the machine learning model includes eight layers, layers 1 to 4 of submodels of the machine learning model are allocated to a first part of nodes, and layers 4 to 8 of submodels of the machine learning model are allocated to a second part of nodes, a submodel allocated to any node in the first part of nodes and a submodel allocated to any node in the second part of nodes may be cascaded to form the complete machine learning model. In the unified splitting mode, submodels in all the third nodes include a same network layer, an output layer of the submodel is an input layer of the submodel in the i^{th} node, and the i^{th} node may perform forward propagation by using the fourth data sent by the at least one third node, to expand a dataset for forward propagation. Submodels in all the fourth nodes include a same network layer, an input layer of the submodel is an output layer of the submodel in the i^{th} node, and the i^{th} node may perform backpropagation by using the sixth data sent by the at least one fourth node, to expand a dataset for backpropagation. Structure information of a submodel in each node may include a network layer in the submodel and a layer index of the network layer in the submodel. In this case, when inter-group information exchange is performed, the i^{th} node may determine, based on a layer index sent by another node, whether to receive output data or gradient data sent by the node.

In a possible implementation, the at least one third node forms a node cluster, and the node cluster corresponds to a node cluster index; and the method further includes:

The i^{th} node receives the node cluster index sent by the at least one third node.

The i^{th} node receives, based on the node cluster index, the fourth data sent by the at least one third node.

In this implementation, in the unified splitting mode, when sending the fourth data to the i^{th} node, the at least one third node further sends the node cluster index of the node cluster to which the at least one third node belongs. The i^{th} node determines, based on the node cluster index, whether the fourth data is from a node in the node cluster, and if yes, receives the fourth data sent by the at least one third node.

In a possible implementation, the at least one fourth node forms a node cluster, and the node cluster corresponds to a node cluster index; and the method further includes:

The i^{th} node receives the node cluster index sent by the at least one fourth node.

The i^{th} node receives, based on the node cluster index, the sixth data sent by the at least one fourth node.

In this implementation, in the unified splitting mode, when sending the sixth data to the i^{th} node, the at least one fourth node further sends the node cluster index of the node cluster to which the at least one fourth node belongs. The i^{th} node determines, based on the node cluster index, whether the sixth data is from a node in the node cluster, and if yes, receives the sixth data sent by the at least one fourth node.

In a possible implementation, the method further includes:

The i^{th} node receives a third-layer index sent by at least one fifth node, where the third-layer index is a layer index of a last layer that is of a submodel in each fifth node and that is in the machine learning model, and the at least one fifth node and the i^{th} node are different nodes.

The i^{th} node determines the at least one third node from the at least one fifth node based on the third-layer index, where the submodel in the i^{th} node includes a network layer corresponding to the third-layer index.

The i^{th} node receives the fourth data sent by the at least one third node.

In this implementation, in a customized splitting mode, the at least one fifth node may be a node that completes forward propagation. In addition to sending output data to the i^{th} node, this type of node further sends the layer index of the last layer of the submodel (namely, the third-layer index). The i^{th} node matches the third-layer index with the layer index of the network layer of the allocated submodel, to determine the at least one third node from the at least one fifth node, and receives the fourth data sent by the at least one third node. Therefore, it can be ensured that the i^{th} node can perform forward propagation by using the fourth data sent by the at least one third node.

In a possible implementation, the method further includes:

The i^{th} node receives a fourth-layer index sent by at least one sixth node, where the fourth-layer index is a layer index of a first layer that is of a submodel in each sixth node and that is in the machine learning model, and the at least one sixth node and the i^{th} node are different nodes.

The i^{th} node determines the at least one fourth node from the at least one sixth node based on the fourth-layer index, where the submodel in the i^{th} node includes a network layer corresponding to the fourth-layer index.

The i^{th} node receives the sixth data sent by the at least one fourth node.

In this implementation, in the customized splitting mode, the at least one sixth node may be a node that completes backpropagation. In addition to sending output gradient data to the i^{th} node, this type of node further sends the layer index of the first layer of the submodel (namely, the fourth-layer index). The i^{th} node matches the fourth-layer index with the layer index of the network layer of the allocated submodel, to determine the at least one fourth node from the at least one sixth node, and receives the sixth data sent by the at least one fourth node. Therefore, it can be ensured that the i^{th} node can perform backpropagation by using the sixth data sent by the at least one fourth node.

In a possible implementation, that the i^{th} node performs gradient backpropagation based on the sixth data includes:

The i^{th} node performs gradient backpropagation based on the sixth data after a second moment, where the second moment is a moment at which the plurality of nodes all complete forward propagation.

In this implementation, the plurality of nodes first perform forward propagation by using the output data exchanged between the nodes, and then perform backpropagation by using the gradient data exchanged between the nodes. The second moment is used as a demarcation point between forward propagation and backpropagation. After all the nodes complete forward propagation, the i^{th} node performs gradient backpropagation, to ensure that the plurality of nodes can synchronously perform backpropagation.

In a possible implementation, the distributed system includes a plurality of node groups, each node group includes the at least two nodes, and the plurality of nodes include nodes in the plurality of node groups; the i^{th} node is any node in any one of the plurality of node groups; the at least one third node includes an (i−1)^{th} node in a node group to which the i^{th} node belongs and/or at least one node in a node group other than the node group to which the i^{th} node belongs; and the at least one fourth node includes an (i+1)^{th} node in the node group to which the i^{th} node belongs and/or the at least one node in the node group other than the node group to which the i^{th} node belongs.

In this implementation, the at least one third node includes the (i−1)^{th} node in the node group to which the i^{th} node belongs and/or at least one node in another node group. In this case, the i^{th} node may perform forward propagation by using output data of an intra-group and/or inter-group cut layer. The at least one fourth node includes the (i+1)^{th} node in the node group to which the i^{th} node belongs and/or at least one node in another node group. In this case, the i^{th} node may perform backpropagation by using gradient data output by an intra-group and/or inter-group cut layer. The plurality of node groups may simultaneously perform intra-group or inter-group exchange of output data or gradient data. Each node group may train and update an allocated submodel by using output data and gradient data of another node group. This expands a dataset of each node group to an extent, and helps improve a training effect of a global model in each node group.

According to a third aspect, this application provides a node for training a machine learning model in a distributed system. The node has a function of implementing the method embodiment in the first aspect. The function may be implemented by hardware, or may be implemented by hardware executing corresponding software. The hardware or the software includes one or more modules corresponding to the foregoing function.

In a possible implementation, the distributed system includes a plurality of node groups, each node group includes a plurality of nodes, each node includes a submodel of the machine learning model, submodels in the plurality of nodes in a same node group are sequentially cascaded to form the machine learning model, and each node includes a first transceiver unit and a first processing unit.

A first transceiver unit of an i^{th} node in a first node group is configured to obtain second data based on first data and a submodel in the i^{th} node, where the first node group is any node group in the plurality of node groups, the i^{th} node is any node in the first node group, and the first data is local data of the i^{th} node or output data sent by an (i−1)^{th} node in the same node group.

A first processing unit of the i^{th} node is configured to perform gradient backpropagation based on third data, to obtain first gradient information of the i^{th} node, where the third data is output data sent by an (i+1)^{th} node in the same node group or local output data.

The first transceiver unit of the i^{th} node is further configured to receive a model parameter sent by at least one first node, where the first node is a node in a second node group, and the second node group is a node group other than the first node group.

The first processing unit of the i^{th} node is further configured to update a parameter of a local submodel based on the model parameter.

In a possible implementation, structure information of a submodel in the first node is the same as structure information of the submodel in the i^{th} node, or structure information of a submodel in the first node is different from structure information of the submodel in the i^{th} node.

The structure information includes one or more of the following: a network layer included in the submodel; and a layer index of the network layer that is included in the submodel and that is in the machine learning model.

In a possible implementation, nodes that store a same submodel in the plurality of node groups form a node cluster, each node cluster corresponds to a node cluster index, and the i^{th} node and the at least one first node correspond to a first node cluster index.

In a possible implementation, the at least one first node includes each node in at least one second node group.

In a possible implementation, each node group corresponds to a node group index, and a node in each node group has a corresponding node index; and the first transceiver unit of the i^{th} node is further configured to:
receive a node group index of the at least one second node group and a node index of a node in the at least one second node group.

The first processing unit of the i^{th} node is further configured to cascade, based on the received node group index and node index, a model parameter sent by the first node in each second node group, to obtain a parameter of each network layer of the machine learning model.

The first processing unit of the i^{th} node is specifically configured to:
obtain, from the parameter of each network layer, a parameter corresponding to a first-layer index, where the first-layer index is a layer index of a network layer that is included in the submodel in the i^{th} node and that is in the machine learning model; and
update the parameter of the local submodel based on the obtained parameter corresponding to the first-layer index and a parameter of a local model.

In a possible implementation, the at least one first node is determined based on a second-layer index sent by a node in each second node group, the second-layer index is a layer index of a network layer that is included in a submodel in the node in each second node group and that is in the machine learning model, a second-layer index of the at least one first node and a first-layer index include a same layer index, and the first-layer index is a layer index of a network layer that is included in the submodel in the i^{th} node and that is in the machine learning model.

In a possible implementation, the first processing unit of the i^{th} node is specifically configured to:
update the parameter of the local submodel based on the model parameter sent by the at least one first node and a parameter of a local model.

In a possible implementation, the first transceiver unit of the i^{th} node is specifically configured to:
receive, after a first moment, the model parameter sent by the at least one first node, where the first moment is a moment at which the plurality of node groups complete one or more rounds of local training.

It should be noted that, for beneficial effects of the third aspect, refer to the descriptions of the first aspect. Details are not described herein again.

According to a fourth aspect, this application further provides a node for training a machine learning model in a distributed system. The node has a function of implementing the method embodiment in the second aspect. The function may be implemented by hardware, or may be implemented by hardware executing corresponding software. The hardware or the software includes one or more modules corresponding to the foregoing function.

In a possible implementation, the distributed system includes a plurality of nodes, each node includes a submodel of the machine learning model, submodels in at least two nodes are sequentially cascaded to form the machine learning model, and each node includes a second processing unit.

A second processing unit of an i^{th} node is configured to: obtain fifth data based on fourth data and a submodel in the i^{th} node, where the i^{th} node is any node in the plurality of nodes, the fourth data is local data of the i^{th} node or data sent by at least one third node, and the at least one third node and the i^{th} node are different nodes; and perform gradient backpropagation based on sixth data, to obtain second gradient information of the i^{th} node, where the sixth data is output data sent by at least one fourth node or local output data of the i^{th} node, and the at least one fourth node and the i^{th} node are different nodes.

In a possible implementation, submodels in the at least one third node have same structure information, and/or submodels in the at least one fourth node have same structure information.

The structure information includes one or more of the following: a network layer included in the submodel; and a layer index of the network layer that is included in the submodel and that is in the machine learning model.

In a possible implementation, the at least one third node forms a node cluster, and the node cluster corresponds to a node cluster index. Each node further includes a second transceiver unit, and a second transceiver unit of the i^{th} node is configured to receive the node cluster index sent by the at least one third node.

The second processing unit of the i^{th} node is further configured to receive, based on the node cluster index, the fourth data sent by the at least one third node.

In a possible implementation, the at least one fourth node forms a node cluster, and the node cluster corresponds to a node cluster index. The second transceiver unit of the i^{th} node is further configured to receive the node cluster index sent by the at least one fourth node.

The second processing unit of the i^{th} node is further configured to receive, based on the node cluster index, the sixth data sent by the at least one fourth node.

In a possible implementation, the second transceiver unit of the i^{th} node is further configured to receive a third-layer index sent by at least one fifth node, where the third-layer index is a layer index of a last layer that is of a submodel in each fifth node and that is in the machine learning model, and the at least one fifth node and the i^{th} node are different nodes.

The second processing unit of the i^{th} node is further configured to determine the at least one third node from the at least one fifth node based on the third-layer index, where the submodel in the i^{th} node includes a network layer corresponding to the third-layer index.

The second transceiver unit of the i^{th} node is further configured to receive the fourth data sent by the at least one third node.

In a possible implementation, the second transceiver unit of the i^{th} node is further configured to receive a fourth-layer index sent by at least one sixth node, where the fourth-layer index is a layer index of a first layer that is of a submodel in each sixth node and that is in the machine learning model, and the at least one sixth node and the i^{th} node are different nodes.

The second processing unit of the i^{th} node is further configured to determine the at least one fourth node from the at least one sixth node based on the fourth-layer index, where the submodel in the i^{th} node includes a network layer corresponding to the fourth-layer index.

The second transceiver unit of the i^{th} node receives the sixth data sent by the at least one fourth node.

In a possible implementation, the second processing unit of the i^{th} node is specifically configured to perform gradient backpropagation based on the sixth data after a second moment, where the second moment is a moment at which the plurality of nodes all complete forward propagation.

In a possible implementation, the distributed system includes a plurality of node groups, each node group includes the at least two nodes, and the plurality of nodes include nodes in the plurality of node groups; the i^{th} node is any node in any one of the plurality of node groups; the at least one third node includes an (i−1)^{th} node in a node group to which the i^{th} node belongs and/or at least one node in a node group other than the node group to which the i^{th} node belongs; and the at least one fourth node includes an (i+1)^{th} node in the node group to which the i^{th} node belongs and/or the at least one node in the node group other than the node group to which the i^{th} node belongs.

It should be noted that, for beneficial effects of the fourth aspect, refer to the descriptions of the second aspect. Details are not described herein again.

According to a fifth aspect, this application provides a node device, including a processor, a memory, a communication interface, and one or more programs. The one or more programs are stored in the memory, and when the one or more programs are configured to be executed by the processor, the one or more programs cooperate with the communication interface to implement the method according to any one of the first aspect or the second aspect.

According to a sixth aspect, this application provides a computer-readable storage medium. The computer-readable storage medium stores program code to be executed by a device. The program code is used to implement the method according to any one of the first aspect or the second aspect.

According to a seventh aspect, this application provides a computer program product, including a computer program. When the computer program product runs on a device, the device is enabled to perform the method according to any one of the first aspect or the second aspect.

### BRIEF DESCRIPTION OF DRAWINGS

To describe the technical solutions in embodiments of the present disclosure or in the background more clearly, the following describes the accompanying drawings for describing embodiments of the present disclosure or the background.

FIG. 1 is a diagram of a model training method based on splitting learning according to a related technology;

FIG. 2 is a diagram of another model training method based on splitting learning according to a related technology;

FIG. 3 is a diagram of a system architecture according to an embodiment of this application;

FIG. 4 is a schematic flowchart of a method for training a machine learning model in a distributed system according to an embodiment of this application;

FIG. 5 is a diagram of a distributed system according to an embodiment of this application;

FIG. 6 is a diagram of splitting a global model according to an embodiment of this application;

FIG. 7 is a diagram of splitting a machine learning model in a unified manner according to an embodiment of this application;

FIG. 8 is a diagram of synchronous interaction in a unified splitting mode according to an embodiment of this application;

FIG. 9 is a diagram of asynchronous interaction in a unified splitting mode according to an embodiment of this application;

FIG. 10 is a diagram of asynchronous interaction in another unified splitting mode according to an embodiment of this application;

FIG. 11 is a diagram of splitting a machine learning model in a customized manner according to an embodiment of this application;

FIG. 12 is a diagram of interaction in a customized splitting mode according to an embodiment of this application;

FIG. 13 is a diagram of interaction in another customized splitting mode according to an embodiment of this application;

FIG. 14 is a schematic flowchart of another method for training a machine learning model in a distributed system according to an embodiment of this application;

FIG. 15 is a diagram of forward propagation in synchronous interaction in a unified splitting mode according to an embodiment of this application;

FIG. 16 is a diagram of forward propagation in asynchronous interaction in a unified splitting mode according to an embodiment of this application;

FIG. 17 is a diagram of forward propagation in a customized splitting mode according to an embodiment of this application;

FIG. 18 is a diagram of backpropagation in a customized splitting mode according to an embodiment of this application;

FIG. 19 is a diagram of a structure of a node for training a machine learning model in a distributed system according to an embodiment of this application;

FIG. 20 is a diagram of a structure of another node for training a machine learning model in a distributed system according to an embodiment of this application; and

FIG. 21 is a diagram of a structure of a node device according to an embodiment of this application.

### DESCRIPTION OF EMBODIMENTS

In the specification, claims, and accompanying drawings of this application, terms “first”, “second”, “third”, “fourth” and the like are intended to distinguish between different objects but do not indicate a particular sequence. In addition, terms “include” and “have” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

“Embodiments” mentioned in the specification mean that specific features, structures, or characteristics described in combination with embodiments may be included in at least one embodiment of this application. The phrase shown in various positions in the specification may not necessarily refer to a same embodiment, and is not an independent or optional embodiment exclusive from another embodiment. It is explicitly and implicitly understood by persons skilled in the art that embodiments described in the specification may be combined with another embodiment.

Terms such as “component”, “module”, and “system” used in this specification are used to indicate computer-related entities, hardware, firmware, combinations of hardware and software, software, or software being executed. For example, a component may be, but is not limited to, a process that runs on a processor, a processor, an object, an executable file, an execution thread, a program, and/or a computer. As illustrated in figures, both a terminal device and an application that runs on the terminal device may be components. One or more components may reside within a process and/or a thread of execution, and a component may be located on one computer and/or distributed between two or more computers. In addition, these components may be executed from various computer-readable media that store various data structures. For example, the components may communicate through a local and/or remote process and based on, for example, a signal having one or more data packets (for example, data from two components interacting with another component in a local system, a distributed system, and/or across a network, like an internet interacting with another system through the signal).

To facilitate understanding of embodiments of this application, and further analyze and provide a technical problem to be specifically resolved in this application, the following briefly describes related technical solutions of this application.

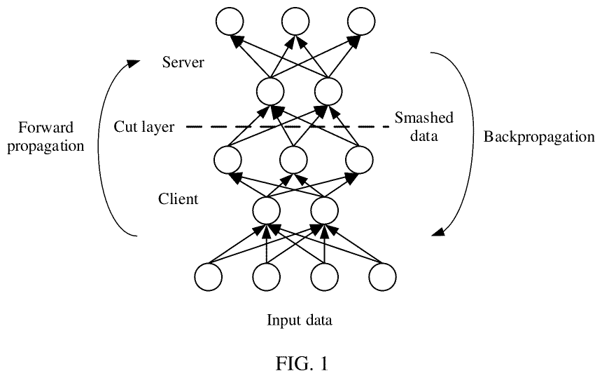

FIG. 1 shows a model training method based on splitting learning provided in a related technology. In splitting learning, an artificial intelligence (AI) model is split into a plurality of parts, and each part is allocated to one node, submodels in a plurality of nodes jointly form a complete AI model. All layers of the AI model shown in FIG. 1 are split into two parts. All layers from an input layer to a cut layer are allocated to a node, and the node may also be referred to as a client. All layers from the cut layer to an output layer are allocated to another node, and the node may also be referred to as a server. A last layer of the client and a first layer of the server are the same, and both are cut layers. Data of the cut layer may be referred to as smashed data.

A specific training process is as follows:

Model training starts from an input layer on a client side. The client determines an output of each layer based on an input, a weight, and an activation function of each layer, and performs forward propagation layer by layer until a last cut layer of the client is reached. The client sends an output of the cut layer to the server.

The server uses received output data as an input of a first cut layer of the server and continues to perform forward propagation layer by layer until a last layer of the server is reached.

The server performs gradient backpropagation based on a loss function. Gradient information is propagated layer by layer from the last layer of the server to the cut layer. Then, the gradient of the cut layer is sent to the client.

The client continues to perform gradient backpropagation from the cut layer to a first input layer.

It can be learned from the foregoing process that, in splitting learning, a model is allocated to a plurality of nodes, so that computing load of a single node can be effectively reduced. In addition, instead of parameters of an entire model, only output data and gradient information of a cut layer need to be transmitted between different devices. This greatly reduces communication overheads between nodes.

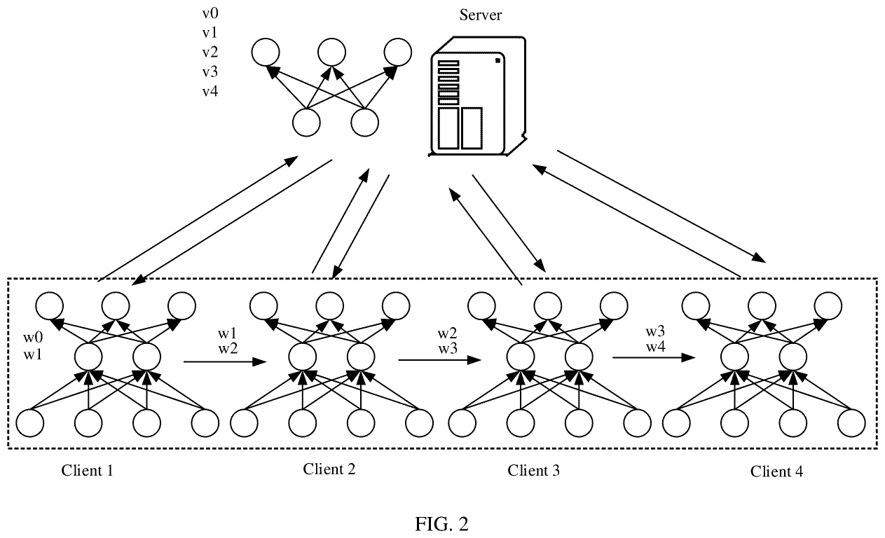

To fully use data information of the plurality of nodes, FIG. 2 provides another model training method based on splitting learning. As shown in FIG. 2, an AI model is split into two parts. A first part is jointly trained by four clients, and a second part is trained by one server.

A specific training process is as follows:

Model training starts from an input layer on a first client side. A first client and the server complete one iteration of model parameters through layer-by-layer forward propagation and gradient backpropagation. It is assumed that initial model parameters of the server of the client are w0 and v0 respectively, and the model parameters of the server of the client are respectively updated to w1 and v1 through one iteration.

The first client sends the model parameter w1 to a second client. The second client and the server complete one iteration of the model parameter through layer-by-layer forward propagation and gradient backpropagation. The model parameters of the server of the second client are updated to w2 and v2 respectively.

The second client sends the model parameter w2 to a third client. The third client and the server complete one iteration of the model parameter through layer-by-layer forward propagation and gradient backpropagation. The model parameters of the server of the third client are updated to w3 and v3 respectively.

The third client sends the model parameter w3 to a fourth client. The fourth client and the server complete one iteration of the model parameter through layer-by-layer forward propagation and gradient backpropagation. The model parameters of the server of the fourth client are updated to w4 and v4 respectively.

It can be learned from the foregoing process that, when there are a plurality of clients, each client may perform model iteration with the server by using local data, so that the entire model can be trained by using data of the plurality of clients. This effectively increases a scale of training samples, and avoids a limitation of data of a single client. However, because there is only one server, interaction with the server is required in each iteration. Especially when there are a plurality of clients, the plurality of clients need to interact with the server in a specific sequence to complete one training. Therefore, an existing splitting learning framework may also be considered as centralized learning. If link quality of the server is poor, an iteration is interrupted, and other clients cannot perform subsequent training. As a result, a training delay increases. In addition, when a quantity of participating clients increases, the training delay further increases, and finally training efficiency is decreased.

Based on disadvantages of the conventional technology, embodiments of this application provide a method for training a machine learning model in a distributed system and a related apparatus, to reduce a model training delay and improve training efficiency while ensuring a data scale of model training in splitting learning.

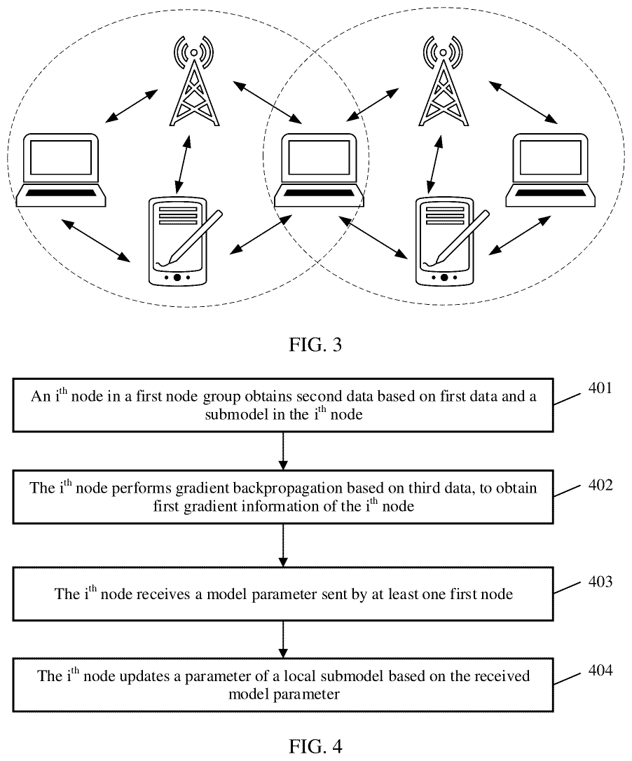

FIG. 3 is a diagram of a system architecture according to an embodiment of this application. As shown in FIG. 3, the system is a network system in which a base station communicates with a terminal device, a base station communicates with another base station, and a terminal device communicates with another terminal device. Each device in the system may be used as a node for model training in splitting learning. The base stations may communicate with each other via a backhaul link. The backhaul link may be a wired backhaul link (for example, an optical fiber or a copper cable), or may be a wireless backhaul link (for example, a microwave). The terminal device may communicate with a corresponding base station through a radio link.

The base station is configured to provide a radio access service for the terminal device. Specifically, each base station corresponds to a service coverage area, and a terminal device entering the area may communicate with the base station by using a radio signal, to receive a radio access service provided by the base station. Service coverage areas of base stations may overlap, and a terminal device in an overlapping area may receive radio signals from a plurality of base stations. Therefore, the plurality of base stations may simultaneously provide services for the terminal device.

Depending on a used wireless communication technology, a base station may also be referred to as a NodeB, an evolved NodeB (eNodeB), an access point (AP), or the like. In addition, based on sizes of provided service coverage areas, the base stations may be further classified into a macro base station for providing a macro cell, a micro base station for providing a micro cell (Pico cell), and a femto base station for providing a femto cell. As a wireless communication technology continuously evolves, a future base station may also use another name.

The terminal device may be various wireless communication devices having a wireless communication function, including but not limited to, a mobile cellular phone, a cordless phone, a personal digital assistant (PDA), a smartphone, a notebook computer, a tablet computer, a wireless data card, a wireless modem (Modem), a wearable device like a smartwatch, or the like. As an internet of things (IoT) technology emerges, increasingly more devices that previously have no communication function, for example, a household appliance, a transportation tool, a tool device, a service device, and a service facility, start to obtain a wireless communication function by being configured with a wireless communication unit, so as to access a wireless communication network, and accept remote control. Such a device has the wireless communication function because the device is configured with the wireless communication unit, and therefore also belongs to a scope of wireless communication devices. In addition, the terminal device may also be referred to as a mobile station, a mobile device, a mobile terminal, a wireless terminal, a handheld device, a client, or the like.

With reference to the accompanying drawings, the following describes in detail a method for training a machine learning model in a distributed system and a related apparatus provided in embodiments of this application.

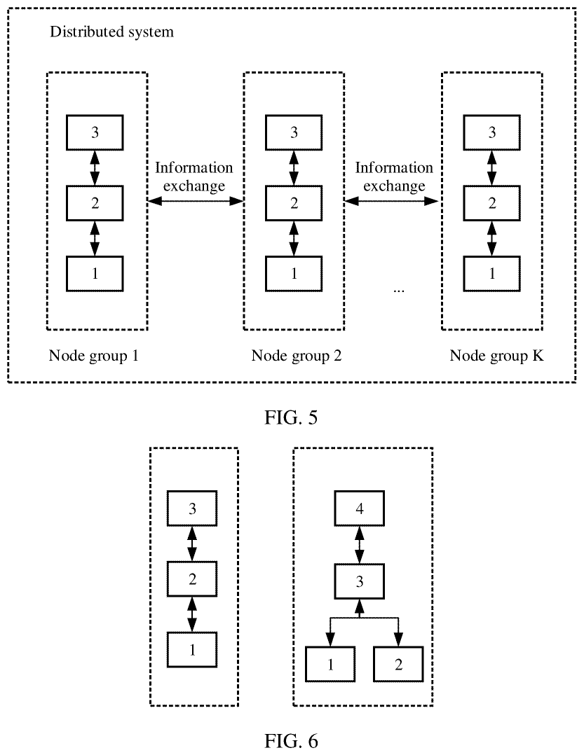

FIG. 4 is a schematic flowchart of a method for training a machine learning model in a distributed system according to an embodiment of this application. As shown in FIG. 5, the distributed system may include a plurality of node groups, each node group includes a plurality of nodes, the machine learning model is split into a plurality of submodels in each node group, each submodel is allocated to one node in the node group, and submodels in a plurality of nodes in one node group are sequentially cascaded to form the complete machine learning model. It should be understood that a to-be-trained submodel may be allocated to each node based on a capability of the node. Each node group may split the machine learning model in sequence or in sequence and parallel. As shown in FIG. 6, three nodes on the left split a global model completely in sequence, and each node sends an output of a cut layer to a next node. Four nodes on the right split the global model in sequence and parallel. Node 1 and node 2 split a first part of the model in parallel. Outputs of node 1 and node 2 are cascaded and then sent to an input layer of node 3. Node 3 and node 4 split the remaining of the model in sequence. The method may be performed by the device (for example, user equipment (UE), the base station, or a road side unit (RSU)) in FIG. 3. For example, as shown in FIG. 4, the method may include the following steps.

401: An i^{th} node in a first node group obtains second data based on first data and a submodel in the i^{th} node.

In embodiments of this application, the first node group is any one of the plurality of node groups, and the i^{th} node is any node in the first node group. When the i^{th} node is the first node in the first node group, the first data is local data of the i^{th} node, for example, local training data of the i^{th} node. When the i^{th} node is not the 1^{st} node in the first node group, the first data is output data sent by an (i−1)^{th} node in a node group to which the i^{th} node belongs, and the output data is obtained by performing forward propagation on input data by using a submodel in the (i−1)^{th} node. The i^{th} node performs forward propagation on the first data by using the allocated submodel, to obtain the second data.

402: The i^{th} node performs gradient backpropagation based on third data, to obtain first gradient information of the i^{th} node.

In embodiments of this application, when the i^{th} node is the last node in the first node group (in other words, the submodel allocated to the i^{th} node is the last part of the machine learning model), the third data is local output data of the last node, and the local output data of the last node may be obtained based on the second data. The i^{th} node may perform backpropagation on the local output data based on the allocated submodel, to obtain the first gradient information, so as to complete parameter update of the allocated submodel. When the i^{th} node is not the last node in the first node group, the third data is output data sent by an (i+1)^{th} node, and the output data is accumulated gradient information obtained by the (i+1)^{th} node. The i^{th} node performs backpropagation on the third data based on the allocated submodel, to obtain the first gradient information. It should be understood that when the i^{th} node is not the 1^{st} node in the first node group, the i^{th} node sends the third data to the (i−1)^{th} node in the group, and the (i−1)^{th} node performs backpropagation.

403: The i^{th} node receives a model parameter sent by at least one first node.

In embodiments of this application, the first node is a node in a second node group, and the second node group is a node group other than the first node group. If the 1^{st} node (for example, a client node) in the first node group completes gradient backpropagation, it indicates that the node group to which the i^{th} node belongs completes one round of local training. Based on different capabilities of nodes in the node groups, when a part of node groups complete one round of local training, some other node groups may complete a plurality of rounds of local training. One round of global training of the plurality of node groups includes at least one round of local training in each node group and one inter-group parameter exchange of the plurality of node groups. To be specific, after training starts, each node group needs to complete at least one round of local training and then perform inter-group model parameter exchange, and the entire model needs a plurality of rounds of global training until the model is converged.

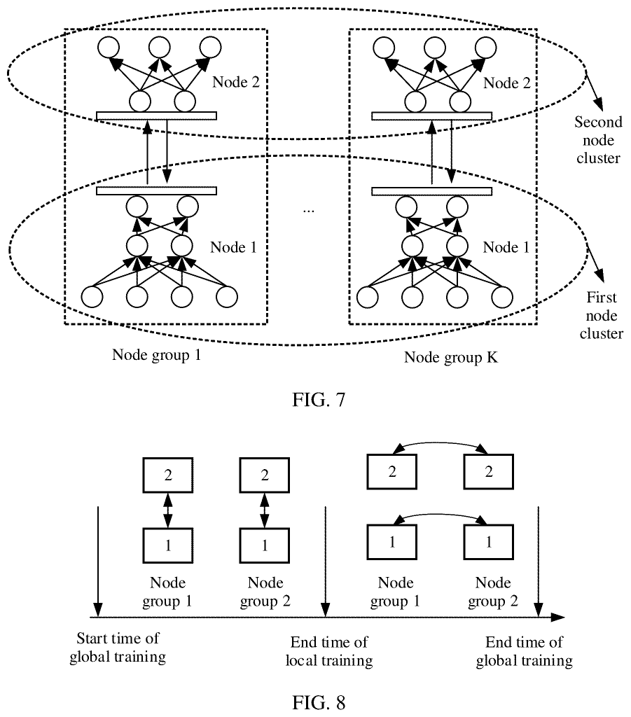

For example, as shown in FIG. 7, the plurality of node groups may split the machine learning model in a unified manner. In FIG. 7, there are a total of K node groups, each node group includes two nodes, and splitting modes of all the node groups are the same. It is assumed that a global model includes four layers, node 1 in each node group is allocated to the first three layers, and node 2 in each node group is allocated to the last two layers. The last layer of node 1 and the first layer of node 2 are the same, and both are cut layers. In a unified splitting mode, structure information of a submodel in the first node is the same as structure information of the submodel in the i^{th} node. The structure information includes one or more of the following: a network layer included in the submodel; and a layer index of the network layer that is included in the submodel and that is in the machine learning model, where the network layer included in the submodel may be one or more layers, each layer has a quantity of neurons, and each layer corresponds to a layer index of the layer in the machine learning model. In this implementation, the i^{th} node may receive the model parameter sent by the first node to which a same submodel is allocated. In the unified splitting mode, efficiency of inter-group data exchange can be improved, and complexity of processing received information can be reduced. Structure information of a submodel in each node may include a network layer in the submodel and/or a layer index of the network layer in the submodel. In this case, when inter-group model parameter exchange is performed, each node may determine, based on a layer index sent by another node, whether to receive a model parameter sent by the node.

For example, in the unified splitting mode, nodes that are in the plurality of node groups and to which a same network layer is allocated form a node cluster, and each node cluster corresponds to a node cluster index. For example, in FIG. 7, nodes 1 in all node groups form a first node cluster, and nodes 2 in all the node groups form a second node cluster. The i^{th} node receives at least one node cluster index sent by at least one second node, where the node cluster index is an index of a node cluster to which the second node belongs, the at least one second node is in a one-to-one correspondence with the at least one node cluster index, and the second node is a node in the second node group. The i^{th} node determines the at least one first node from the at least one second node based on the at least one node cluster index. Specifically, the i^{th} node determines, as the first node, a node that is in the at least one second node and whose node cluster index is the same as a first node cluster index, where the first node cluster index is an index of a node cluster to which the i^{th} node belongs.

In this implementation, in the unified splitting mode, the at least one first node is a node that belongs to a same node cluster as the i^{th} node, and a node cluster index of the node cluster is the first node cluster index. In this case, the i^{th} node may determine, based on a node cluster index sent by another node, at least one first node that belongs to a same node cluster, and then receive a model parameter sent by the at least one first node, so that the parameter of the local submodel is subsequently updated by using the model parameter sent by the at least one first node.

For example, in the unified splitting mode, the plurality of node groups may use a synchronous interaction mode. In other words, the plurality of node groups have same start time and end time of global training and same end time of at least one round of local training in the groups, and the plurality of node groups are trained based on unified time. In this scenario, the at least one first node includes a node that is in each second node group and that belongs to a same node cluster as the i^{th} node. For example, in the two node groups shown in FIG. 8, at least one round of local training is first performed on each of node group 1 and node group 2. Each round of training includes a forward layer-by-layer output and gradient backpropagation. After each round of training ends, a model parameter is updated once. When intra-group training of all groups is completed, all nodes included in a same node cluster exchange model parameters. For example, node 1 in node group 1 sends a model parameter to node 1 in another node group, and node 1 in node group 2 sends a model parameter to node 1 in another node group. Each node identifies, based on a node cluster index of a sending node, whether the sending node and the node belong to a same node cluster, and receives a model parameter if the sending node and the node belong to a same node cluster.

For example, in the synchronous interaction mode of unified splitting, a moment at which the plurality of node groups complete one or more rounds of local training is defined as a first moment, and the i^{th} node receives, after the first moment, the model parameter sent by the at least one first node, to ensure that the plurality of node groups can synchronously perform inter-group parameter exchange.

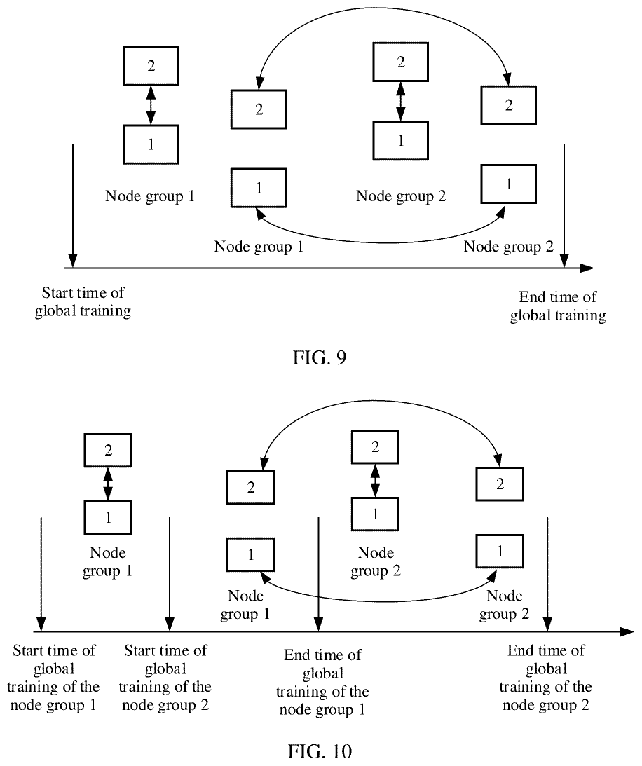

For example, in the unified splitting mode, the plurality of node groups may use an asynchronous interaction mode. In other words, a part or all of start time and end time of global training of the plurality of node groups, start time and end time of at least one round of local training in the groups, and start time and end time of inter-group parameter exchange are different, and the plurality of node groups are trained based on independent time. As shown in FIG. 9, start time and end time of global training of node group 1 and node group 2 are the same, but end time of at least one round of local training in the group and start time and end time of inter-group parameter exchange are different. After the start time of the global training is reached, node group 1 first performs at least one round of local training in the group. Each round of training includes a forward layer-by-layer output and gradient backpropagation. After each round of training ends, a model parameter is updated once. Subsequently, node group 2 performs at least one round of local training in the group. After each round of training ends, a model parameter is updated once. In this scenario, the at least one first node includes a node that is in at least one second node group and that belongs to a same node cluster as the i^{th} node. In other words, the i^{th} node can receive at least a model parameter sent by at least one first node in a part of the second node group.

For example, in FIG. 9, end time of parameter exchange may be end time of global training. After completing local training, node 1 and node 2 in node group 1 each may send a model parameter to node 1 and node 2 in node group 2, that is, send a model parameter to another node that belongs to a same node cluster. Node 1 and node 2 in node group 2 may first receive the model parameter, for example, receive, based on a node cluster index, a model parameter sent by another node belonging to the same node cluster. Before the end time of global training, each node in node group 1 and node group 2 can receive a model parameter sent by another node included in the same node cluster.

For example, in FIG. 10, end time of parameter exchange may be end time of global training. Node group 1 and node group 2 have different start time and end time of global training, different time of intra-group cut layer information exchange, and different start time and end time of inter-group parameter exchange. After a start moment of global training of node group 1 is reached, node group 1 first performs at least one round of local training in the group. After the local training ends, node 1 and node 2 in node group 1 each may send a model parameter to node 1 and node 2 in node group 2. In this scenario, node 1 and node 2 in node group 1 may not receive, before the end time of global training, model parameters sent by node 1 and node 2 in node group 2. In this case, in this round of global training, node 1 and node 2 in node group 1 each may not update a local submodel by using the model parameter sent by the node in node group 2.

For example, in the asynchronous interaction mode of unified splitting, to ensure that nodes in each node group can perform inter-group information exchange in each round of global training (that is, ensure that each node group can receive at least model parameters of a part of other node groups), a minimum interval between start time and end time of global training may be set for each node group, so that there is an intersection between time of global training of each node group and time of global training of the part of other node groups.

For example, as shown in FIG. 11, the plurality of node groups may split the machine learning model in different manners. To be specific, nodes in each node group may carry different submodels based on capabilities of the nodes, and do not need to carry a fixed network layer in a unified splitting mode. In FIG. 11, there are a total of K node groups, each node group includes two nodes, and splitting modes of all the node groups may be different. It is assumed that a global model includes four layers, node 1 in node group 1 is allocated to the first three layers, node 2 in node group 1 is allocated to the last two layers, node 1 in node group 2 is allocated to the first two layers, and node 2 in node group 2 is allocated to the last three layers. The last layer of node 1 and the first layer of node 2 are the same, and both are cut layers. In this way, a capability of each node can be fully used, and a network layer that matches a computing capability and a storage capability of each node can be allocated to the node. In a customized splitting mode, structure information of a submodel in the first node is different from structure information of the submodel in the i^{th} node. In this implementation, in the customized splitting mode, the i^{th} node may receive model parameters sent by first nodes to which different submodels are allocated, so that it can be ensured that a node participating in model training can receive at least a model parameter sent by at least one first node in another node group. In this way, each node group can maximize use of information of the another node group through inter-group exchange, to improve training accuracy of the machine learning model.

For example, in the customized splitting mode, the plurality of node groups may use a synchronous interaction mode. In this scenario, the at least one first node includes each node in the second node group. In other words, the i^{th} node receives model parameters sent by all nodes in each of the other node groups. In the customized splitting mode, the plurality of node groups may further use an asynchronous interaction mode. In this scenario, the at least one first node includes each node in at least one second node group.

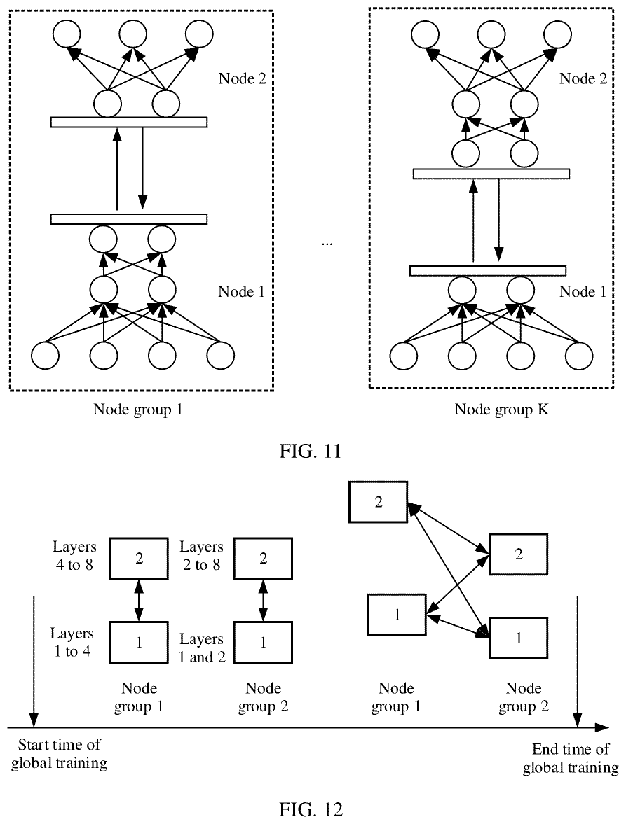

Specifically, when a node in the second node group does not indicate a layer index of an allocated submodel, the i^{th} node needs to receive a model parameter sent by a node in each second node group. As shown in FIG. 12, node 2 in node group 2 needs to receive model parameters of both node 1 and node 2 in node group 1, and node 1 in node group 2 also needs to receive the model parameters of both node 1 and node 2 in node group 1. The same applies to nodes in node group 1.

In this implementation, when a node in the second node group does not indicate a layer index of a submodel allocated to the node, the i^{th} node needs to receive all model parameters sent by all nodes in the at least one second node group, to ensure that the information of the another node group can be fully used.

For example, each node group corresponds to a node group index, and a node in each node group has a corresponding node index; and the method further includes:

The i^{th} node receives a node group index of the at least one second node group and a node index of a node in the at least one second node group.

The i^{th} node cascades, based on the received node group index and node index, a model parameter sent by the first node in each second node group, to obtain a parameter of each network layer of the machine learning model.

Specifically, for example, in FIG. 12, node 2 in node group 2 may cascade received model parameters of node 1 and node 2 in node group 1 based on a node group index of node group 1 and node indexes of node 1 and node 2 in node group 1, to obtain parameters of the global model.

In this implementation, when a node in the second node group does not indicate a network layer index of a submodel allocated to the node, the i^{th} node may cascade, based on a node group index of the second node group and node indexes of nodes in the second node group, model parameters sent by the nodes in the second node group, to obtain a parameter of each network layer of the global model in the second node group.

For example, the method further includes:

The i^{th} node receives a second-layer index sent by a node in each second node group, where the second-layer index is a layer index of a network layer that is included in a submodel in a node in each second node group and that is in the machine learning model.

The i^{th} node determines one or more first nodes from each second node group based on a first-layer index and the second-layer index.

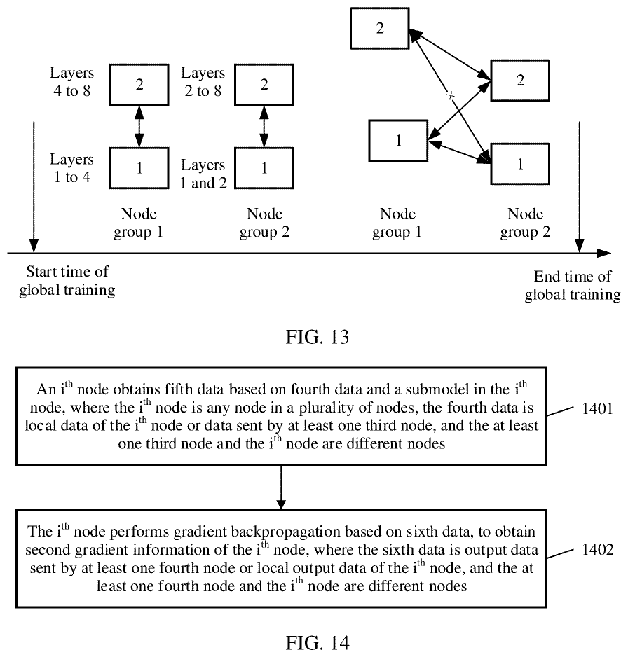

Specifically, for example, in FIG. 13, node 2 in node group 1 matches layer indexes (layers 2 to 8) sent by node 2 in node group 2 with layer indexes (layers 4 to 8) of node 2 in node group 1, and node 2 in node group 1 and node 2 in node group 2 include same layer indexes (layers 4 to 8). In this case, node 2 in node group 1 determines node 2 in node group 2 as the first node, and receives the model parameter sent by node 2 in node group 2.

In this implementation, when the node in the second node group indicates a second-layer index of the submodel allocated to the node, the i^{th} node may determine, based on the second-layer index, one or more first nodes that are in the second node group and that include a same layer index as the first-layer index, and receive the model parameter of the at least one first node. In this way, the model parameter can be received in a targeted manner. This avoids a problem of high bandwidth occupation caused by receiving all model parameters of all sending nodes in the customized splitting mode, and can save storage space of a receiving node.

404: The i^{th} node updates a parameter of a local submodel based on the received model parameter.

In embodiments of this application, in the unified splitting mode, the i^{th} node updates the parameter of the local submodel based on model parameters sent by nodes belonging to a same node cluster and a local parameter of a submodel allocated to the i^{th} node. For example, in FIG. 8, node 2 in node group 1 receives the model parameter sent by node 2 in node group 2, then averages the model parameter sent by node 2 in node group 2 and a local parameter of a local submodel, and updates the parameter of the local submodel by using a calculated average value.

For example, in the customized splitting mode, when the node in the second node group does not indicate the second-layer index of the submodel allocated to the node, that the i^{th} node updates the parameter of the local submodel based on the received model parameter includes:

The i^{th} node obtains, from the received model parameter, a parameter corresponding to a first-layer index, where the first-layer index is a layer index of a network layer that is included in the submodel in the i^{th} node and that is in the machine learning model.

The i^{th} node updates the parameter of the local submodel based on the obtained parameter corresponding to the first-layer index and a parameter of a local model.

Specifically, for example, in FIG. 12, if layer indexes of a submodel included in node 2 in node group 2 are layers 2 to 8, node 2 in node group 2 extracts a parameter of layers 2 to 8 from the received model parameter, averages the extracted parameter of layers 2 to 8 with a parameter of local layers 2 to 8, and updates the parameter of the local submodel by using a calculated average value.

In this implementation, the i^{th} node extract, from the received model parameter based on a first-layer index of a network layer allocated to the i^{th} node, a parameter of the network layer corresponding to the first-layer index, and may further perform parameter update on the stored submodel by fully using the parameter of the network layer corresponding to the first-layer index in the another node group and a local parameter of the allocated submodel.

For example, in the customized splitting mode, when the node in the second node group indicates the second-layer index of the submodel allocated to the node, the i^{th} node updates the parameter of the local submodel based on the model parameter sent by the at least one first node and the parameter of the local model. For example, in FIG. 13, node 2 in node group 1 extracts a model parameter of layers 4 to 8 from model parameters sent by node 2 in node group 2, averages the obtained model parameter of layers 4 to 8 with a model parameter of local layers 4 to 8, and updates the parameter of the local submodel by using a calculated average value.

In this implementation, the i^{th} node may receive only a model parameter sent by one or more first nodes, to quickly perform parameter update on the allocated submodel by using the received model parameter and a local parameter of the allocated submodel.

It can be learned that, in embodiments of this application, a node in the distributed system may flexibly split the machine learning model based on a capability of each node, and information exchange of a cut layer in each node group can be completed in the group, without a need to perform information exchange of the cut layer with a single server node in a centralized manner. This can avoid an increase in an overall model training delay and learning performance degradation that are caused by deep channel fading of the single server node in a centralized training mode, and helps reduce a model training delay and improve model training efficiency. In addition, model parameters may be exchanged between the plurality of node groups, and each node group may update an allocated submodel by using a model parameter of another node group. This expands a dataset of each node group to an extent, and helps improve a training effect of a global model in each node group.

FIG. 14 is a schematic flowchart of another method for training a machine learning model in a distributed system according to an embodiment of this application. The distributed system includes a plurality of nodes, each node includes a submodel of the machine learning model, and submodels in at least two nodes are sequentially cascaded to form the complete machine learning model. For example, as shown in FIG. 14, the method may include the following steps.

1401: An i^{th} node obtains fifth data based on fourth data and a submodel in the i^{th} node, where the i^{th} node is any node in the plurality of nodes, the fourth data is local data of the i^{th} node or data sent by at least one third node, and the at least one third node and the i^{th} node are different nodes.

In embodiments of this application, when the submodel in the i^{th} node includes an input layer of the machine learning model, the fourth data is the local data of the i^{th} node. For example, the machine learning model includes eight layers, and the first layer is an input layer. When the submodel in the i^{th} node includes layers 1 to 4, the fourth data is the local data of the i^{th} node. When the submodel in the i^{th} node does not include the input layer of the machine learning model, the fourth data is data sent by at least one other node (namely, the third node).

When the fourth data is the local data of the i^{th} node, the i^{th} node performs forward propagation on the fourth data by using the allocated submodel, to obtain the fifth data.

When the fourth data is the data sent by the at least one third node, the i^{th} node performs forward propagation based on the fourth data by using the allocated submodel, to obtain the fifth data. For example, the submodel in the i^{th} node includes layers 4 to 8 of the machine learning model, and the fourth data sent by the at least one third node includes output data of a fifth layer of the machine learning model. In this case, when the i^{th} node performs forward propagation to the fifth layer, output data of the fifth layer and the output data of the fifth layer that is sent by the at least one third node are averaged and used as an input of a sixth layer. For example, the plurality of nodes split the machine learning model in a unified splitting mode, the submodel in the i^{th} node includes layers 4 to 8 of the machine learning model, and submodels in the at least one third node have same structure information, and are all layers 2 to 4 of the machine learning model. In this case, the i^{th} node averages the fourth data sent by the at least one third node, and then inputs averaged fourth data into the allocated submodel for forward propagation. The structure information includes one or more of the following: a network layer included in the submodel; and a layer index of the network layer that is included in the submodel and that is in the machine learning model, where the network layer included in the submodel may be one or more layers, each layer has a quantity of neurons, and each layer corresponds to a layer index of the layer in the machine learning model. In this implementation, the plurality of nodes may split the machine learning model in a unified splitting mode. In the unified splitting mode, submodels in all third nodes include a same network layer, an output layer of the submodel is an input layer of the submodel in the i^{th} node, and the i^{th} node may perform forward propagation by using the fourth data sent by the at least one third node, to expand a dataset for forward propagation. Structure information of a submodel in each node may include a network layer in the submodel and a layer index of the network layer in the submodel. In this case, when inter-group information exchange is performed, the i^{th} node may determine, based on a layer index sent by another node, whether to receive output data or gradient data sent by the node. For example, a node group is used as an example for description. The distributed system may include a plurality of node groups, each node group includes at least two nodes, the at least two nodes in each node group are sequentially cascaded to form the machine learning model, the plurality of nodes include nodes in the plurality of node groups, and the i^{th} node may be any node in any one of the plurality of node groups. When the i^{th} node is the 1^{st} node in a node group to which the i^{th} node belongs, the fourth data is the local data of the i^{th} node; or when the i^{th} node is not the 1^{st} node in a node group to which the i^{th} node belongs, the at least one third node includes an (i−1)^{th} node in the node group to which the i^{th} node belongs, and/or at least one node in a node group other than the node group to which the i^{th} node belongs. In this case, the fourth data is output data forward propagated by the (i−1)^{th} node, and/or output data forward propagated by the at least one node in the node group other than the node group to which the i^{th} node belongs.

It should be noted that, the node group is introduced for description to make embodiments of this application clearer. The node group does not constitute a limitation on embodiments of this application. For example, the at least one third node can also be accurately determined based on the structure information of the submodel in the node.

In this implementation, the i^{th} node may perform forward propagation by using output data of an intra-group and/or inter-group cut layer, and the plurality of node groups may simultaneously perform intra-group or inter-group exchange of output data. Each node group may train a stored submodel by using output data of another node group. This expands a dataset of each node group to an extent, and helps improve a training effect of a global model in each node group.

For example, in the unified splitting mode, the at least one third node forms a node cluster, and the node cluster corresponds to a node cluster index; and the method further includes:

The i^{th} node receives the node cluster index sent by the at least one third node.

The i^{th} node receives, based on the node cluster index, the fourth data sent by the at least one third node.

For example, the plurality of node groups split the machine learning model in the unified splitting mode. In the unified splitting mode, the plurality of node groups may use a synchronous interaction mode. In other words, the plurality of node groups have same start time and end time of global training. In addition, the plurality of node groups first perform forward propagation, and then perform backpropagation when forward propagation of all the node groups is completed.

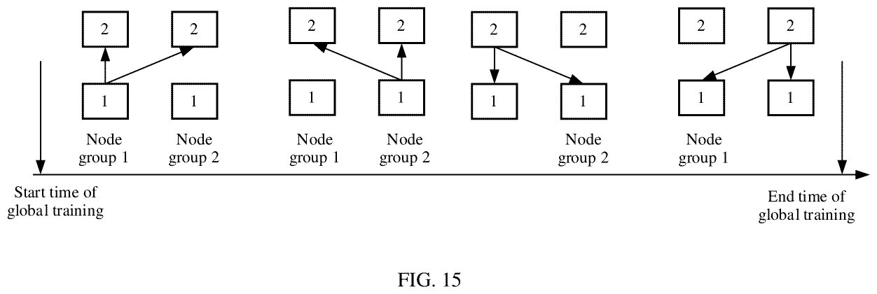

During forward propagation, in addition to receiving the fourth data sent by the (i−1)^{th} node in the current group, the i^{th} node further receives fourth data sent by an (i−1)^{th} node in each of all other node groups, and the (i−1)^{th} node in the current group and the (i−1)^{th} node in each of all the other node groups form the at least one third node. The i^{th} node averages the fourth data sent by the (i−1)^{th} node in the current group and the fourth data sent by the (i−1)^{th} node in another node group, to obtain input data of forward propagation. As shown in FIG. 15, node group 1 and node group 2 have same start time and end time of global training. Node group 1 and node group 2 first perform forward propagation. Then, node group 1 and node group 2 perform backpropagation when forward propagation of both node group 1 and node group 2 is completed. Forward propagation is used as an example. Node 1 in node group 1 not only sends output data to node 2 in node group 1, but also sends the output data to node 2 in node group 2. Node 2 in node group 1 and node 2 in node group 2 belong to a same node cluster. Similarly, node 1 in node group 2 not only sends output data to node 2 in node group 2, but also sends the output data to node 2 in node group 1. Node 2 in node group 1 may receive a node cluster index sent by node 1 in node group 1 and node 1 in node group 2, and determine whether the node cluster index is a target node cluster index (for example, an index of a node cluster to which a previous-hop node belongs). If yes, node 2 in node group 1 receives output data sent by the node.

In this implementation, in the unified splitting mode, when sending the fourth data to the i^{th} node, the at least one third node further sends the node cluster index of the node cluster to which the at least one third node belongs. The i^{th} node determines, based on the node cluster index, whether the fourth data is from a node in the node cluster, that is, determines whether the node cluster index is the target node cluster index, and if yes, receives the fourth data sent by the at least one third node, so as to train the local submodel by using intra-group and/or inter-group output data.

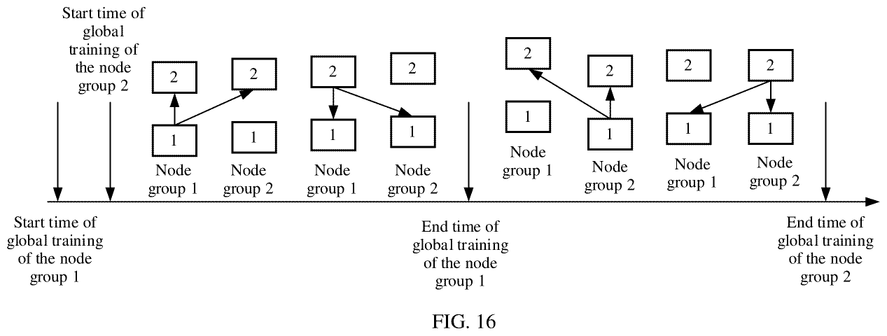

For example, in the unified splitting mode, the plurality of node groups may further use an asynchronous interaction mode. In other words, a part or all of start time and end time of global training of the plurality of node groups, start time and end time of forward propagation, and start time and end time of backpropagation are different. The plurality of node groups are trained based on independent time. Forward propagation is used as an example. In this scenario, the i^{th} node may receive only output data of a cut layer sent by the (i−1)^{th} node in the current group. In this case, the (i−1)^{th} node in the current group is the third node. Alternatively, in addition to receiving the output data of the cut layer sent by the (i−1)^{th} node in the current group, the i^{th} node may further receive output data of a cut layer sent by an (i−1)^{th} node in a part of other node groups. In this case, the (i−1)^{th} node in the current group and the (i−1)^{th} node in the part of other node groups form the at least one third node. The i^{th} node averages the received fourth data to obtain input data of forward propagation. As shown in FIG. 16, node group 1 and node group 2 have different start time and end time of global training. After the start time of global training of node group 1 is reached, node group 1 first performs forward propagation, and sends, during forward propagation, output data of a cut layer to a next-hop node belonging to a same node cluster. In this case, node group 2 has not performed forward propagation, but node 1 and node 2 in node group 2 may first receive the data. Because node group 1 starts forward propagation of an output result earlier than node group 2, node group 1 may not obtain output data sent by a node in node group 2.

It should be understood that, in the unified splitting mode, efficiency of inter-group data exchange can be improved, and complexity of processing received information can be reduced.

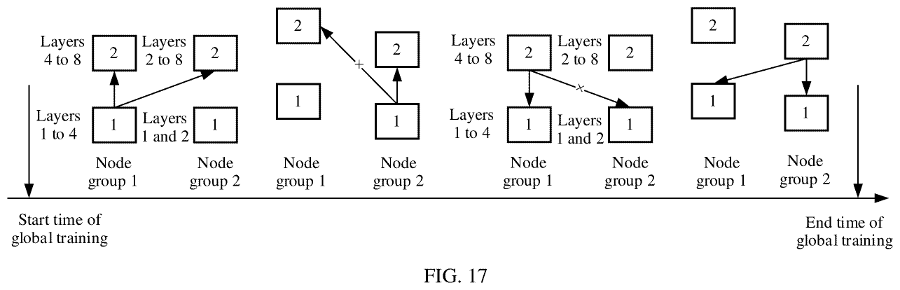

For example, the plurality of node groups split the machine learning model in a customized splitting mode. In the customized splitting mode, the plurality of node groups may use a synchronous interaction mode. The plurality of node groups have same start time and end time of global training and same forward propagation time and backpropagation time of output data. In addition, the plurality of node groups first perform forward propagation, and then perform backpropagation when forward propagation of all the node groups is completed. The (i−1)^{th} node in the current group not only sends output data to the i^{th} node in the current group, but also sends the output data to an i^{th} node in another node group. As shown in FIG. 17, node group 1 and node group 2 first perform forward propagation, and node group 1 and node group 2 perform backpropagation when forward propagation of both node group 1 and node group 2 is completed. Node 1 in node group 1 not only sends output data to node 2 in node group 1, but also sends the output data to node 2 in node group 2. Node 1 in node group 2 not only sends output data to node 2 in node group 2, but also sends the output data to node 2 in node group 1.

For example, in the customized splitting mode, the plurality of node groups may further use an asynchronous interaction mode. A part or all of start time and end time of global training of the plurality of node groups, start time and end time of forward propagation, and start time and end time of backpropagation are different. The plurality of node groups are trained based on independent time. In this scenario, the i^{th} node may receive only output data sent by the (i−1)^{th} node in the current group. Alternatively, in addition to receiving the output data sent by the (i−1)^{th} node in the current group, the i^{th} node may further receive output data sent by an (i−1)^{th} node in a part of other node groups.

For example, in the customized splitting mode, the method further includes:

The i^{th} node receives a third-layer index sent by at least one fifth node, where the third-layer index is a layer index of a last layer that is of a submodel in each fifth node and that is in the machine learning model, and the at least one fifth node and the i^{th} node are different nodes.

The i^{th} node determines the at least one third node from the at least one fifth node based on the third-layer index, where the submodel in the i^{th} node includes a network layer corresponding to the third-layer index.

The i^{th} node receives the fourth data sent by the at least one third node.

Specifically, the at least one fifth node may be the (i−1)^{th} node in the current group, or may be the (i−1)^{th} node in the current group and an (i−1)^{th} node in at least one other node group. The i^{th} node matches each third-layer index with a first-layer index of the allocated submodel. The first-layer index is a layer index of a network layer that is included in the submodel in the i^{th} node and that is in the machine learning model. If the first-layer index includes the third-layer index, the corresponding fifth node is determined as the third node, that is, the submodel in the i^{th} node includes a last layer of a submodel in the fifth node. For another fifth node, because the submodel in the i^{th} node does not include the last layer of the submodel in the i^{th} node, the i^{th} node may not receive data sent by the fifth node. For example, in FIG. 17, node 2 in node group 1 includes layers 4 to 8, and node 1 in node group 2 includes layers 1 and 2. In this case, node 2 in node group 1 may not receive output data sent by node 1 in node group 2.

In this implementation, in the customized splitting mode, the at least one fifth node may be a node that completes forward propagation. In addition to sending output data to the i^{th}node, this type of node further sends the layer index of the last layer of the submodel (namely, the third-layer index). The i^{th} node matches the third-layer index with the layer index of the network layer of the allocated submodel, to determine the at least one third node from the at least one fifth node, and receives the fourth data sent by the at least one third node. Therefore, it can be ensured that the i^{th} node can perform forward propagation by using the fourth data sent by the at least one third node.

It should be understood that, in the customized splitting mode, a capability of each node can be fully used, and a network layer that matches a computing capability and a storage capability of each node can be allocated to the node.

1402: The i^{th} node performs gradient backpropagation based on sixth data, to obtain second gradient information of the i^{th} node, where the sixth data is output data sent by at least one fourth node or local output data of the i^{th} node, and the at least one fourth node and the i^{th} node are different nodes.

In embodiments of this application, when the submodel in the i^{th} node includes an output layer of the machine learning model, that is, the submodel in the i^{th} node is the last part of the machine learning model, in a scenario of a plurality of node groups, the i^{th} node is the last node in a node group to which the i^{th} node belongs, and the i^{th} node calculates an error based on the fifth data, to obtain the sixth data. When the submodel in the i^{th} node does not include the output layer of the machine learning model, the sixth data is output data sent by at least one other node (namely, the fourth node), and the output data is accumulated gradient information obtained by the fourth node. The i^{th} node performs backpropagation on the sixth data based on the allocated submodel, to obtain the second gradient information.

For example, a node group is used as an example for description. In the unified splitting mode, structure information of submodels in the at least one fourth node is the same. For example, the submodel in the i^{th} node includes layers 2 to 4 of the machine learning model, and a submodel in the at least one fourth node includes layers 4 to 8 of the machine learning model. The at least one fourth node includes an (i+1)^{th} node in the node group to which the i^{th} node belongs and/or at least one node in a node group other than the node group to which the i^{th} node belongs. For example, in the synchronous interaction mode of unified splitting, the at least one fourth node includes an (i+1)^{th} node in the current group and nodes (for example, all nodes 2 in FIG. 15) that store a same submodel as the (i+1)^{th} node in all other node groups. In the asynchronous interaction mode of unified splitting, the at least one fourth node includes the (i+1)^{th} node in the current group and nodes that store a same submodel as the (i+1)^{th} node in a part of other node groups.

For example, in the unified splitting mode, the at least one fourth node forms a node cluster, and the node cluster corresponds to a node cluster index; and the method further includes:

The it node receives the node cluster index sent by the at least one fourth node.

The i^{th} node receives, based on the node cluster index, the sixth data sent by the at least one fourth node.

In embodiments of this application, the at least one fourth node further sends, to the i^{th} node, a node cluster index of a node cluster to which the at least one fourth node belongs. The i^{th} node may determine, based on the node cluster index, whether the sixth data is from a node in the node cluster, that is, determine whether the node cluster index is the target node cluster index, and if yes, receive the sixth data sent by the at least one fourth node, so as to train the local submodel by using intra-group and/or inter-group gradient data.

For example, in the customized splitting mode, the method further includes:

The i^{th} node receives a fourth-layer index sent by at least one sixth node, where the fourth-layer index is a layer index of a first layer that is of a submodel in each sixth node and that is in the machine learning model, and the at least one sixth node and the i^{th} node are different nodes.

The i^{th} node determines the at least one fourth node from the at least one sixth node based on the fourth-layer index, where the submodel in the i^{th} node includes a network layer corresponding to the fourth-layer index.

The i^{th} node receives the sixth data sent by the at least one fourth node.

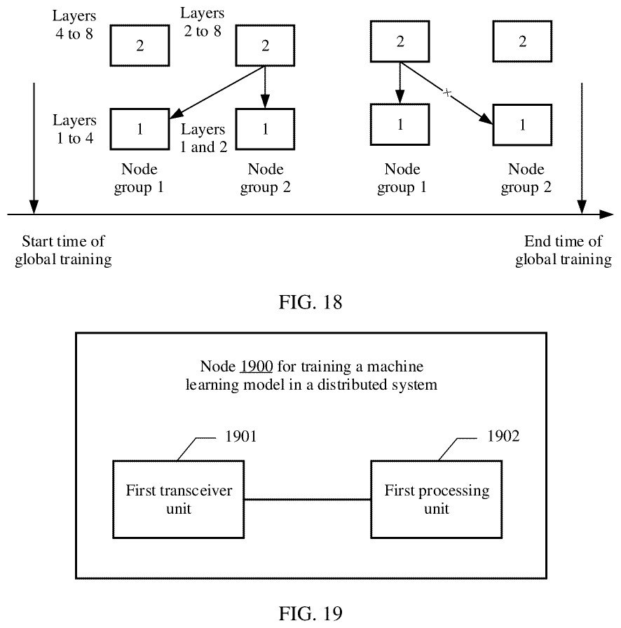

Specifically, the at least one sixth node may be the (i+1)^{th} node in the current group, or may be the (i+1)^{th} node in the current group and an (i+1)^{th} node in at least one other node group. The i^{th} node matches each fourth-layer index with a first-layer index of the allocated submodel. The first-layer index is a layer index of a network layer that is included in the submodel in the i^{th} node and that is in the machine learning model. If the first-layer index includes the fourth-layer index, the corresponding sixth node is determined as the fourth node, that is, the submodel in the i^{th} node includes a first layer of a submodel in the sixth node. For another sixth node, because the submodel in the i^{th} node does not include the first layer of the submodel in the i^{th} node, the i^{th} node may not receive data sent by the sixth node. For example, in FIG. 18, a submodel in node 1 in node group 1 includes a first layer of a submodel in node 2 in node group 2. Therefore, node 1 in node group 1 receives gradient data sent by node 2 in node group 2. However, a submodel in node 1 in node group 2 does not include a first layer of a submodel in node 2 in node group 1. Therefore, node 1 in node group 2 does not receive gradient data sent by node 2 in node group 1.

In this implementation, the at least one fourth node includes the (i+1)^{th} node in the node group to which the i^{th} node belongs and/or at least one node in another node group, and the i^{th} node may perform backpropagation by using gradient data output by an intra-group and/or inter-group cut layer. The plurality of node groups may simultaneously perform intra-group or inter-group exchange of gradient data. Each node group may train and update a stored submodel by using gradient data of another node group. This expands a dataset of each node group to an extent, and helps improve a training effect of a global model in each node group.

When the sixth data is the local output data of the i^{th} node, the i^{th} node performs backpropagation on the sixth data by using the allocated submodel, to obtain the second gradient information, so as to update the parameter of the local submodel.

When the sixth data is the data sent by the at least one fourth node, the i^{th} node performs backpropagation based on the fourth data by using the allocated submodel, to obtain the second gradient information, so as to update the parameter of the local submodel. For example, the submodel in the i^{th} node includes layers 4 to 8 of the machine learning model, and the sixth data sent by the at least one fourth node includes gradient data output by the fifth layer of the machine learning model. In this case, when the i^{th} node performs backpropagation to the fifth layer, the gradient data output by the fifth layer and gradient data that is output by the fifth layer and that is sent by the at least one fourth node are averaged and used as an input of a fourth layer. For example, the plurality of nodes split the machine learning model in the unified splitting mode, the submodel in the i^{th} node includes layers 2 to 4 of the machine learning model, and submodels in the at least one fourth node include layers 4 to 8 of the machine learning model. In this case, the i^{th} node averages the sixth data sent by the at least one fourth node, and then inputs averaged sixth data into the stored submodel for backpropagation.

In this implementation, in the customized splitting mode, the at least one sixth node may be a node that completes backpropagation. In addition to sending output gradient information to the i^{th} node, this type of node further sends the layer index of the first layer of the submodel (namely, the fourth-layer index). The i^{th} node matches the fourth-layer index with the layer index of the network layer of the allocated submodel, to determine the at least one fourth node from the at least one sixth node, and receives the sixth data sent by the at least one fourth node. Therefore, it can be ensured that the i^{th} node can perform backpropagation by using the sixth data sent by the at least one fourth node.

In embodiments of this application, one round of global training of the plurality of node groups includes at least one forward propagation and at least one backpropagation that are simultaneously performed within a group and between groups. Intra-group and inter-group information exchange jointly form one round of global training. The entire model needs a plurality of rounds of global training until the model is converged.

For example, that the i^{th} node performs gradient backpropagation based on the sixth data includes:

The i^{th} node performs gradient backpropagation based on the sixth data after a second moment, where the second moment is a moment at which the plurality of nodes all complete forward propagation. In this implementation, the plurality of nodes first perform forward propagation by using the output data exchanged between the nodes, and then perform backpropagation by using the gradient data exchanged between the nodes. The second moment is used as a demarcation point between forward propagation and backpropagation. After all the nodes complete forward propagation, the i^{th} node performs gradient backpropagation, to ensure that the plurality of nodes can synchronously perform backpropagation.

It can be learned that, in embodiments of this application, a node in the distributed system may flexibly split the machine learning model based on a capability of each node. The i^{th} node may exchange the output data of forward propagation with the at least one third node, and may exchange the output data of backpropagation with the at least one fourth node, without a need to perform information exchange of the cut layer with a single server node in a centralized manner. This can avoid an increase in an overall model training delay and learning performance degradation that are caused by deep channel fading of the single server node in a centralized training mode, and helps reduce a model training delay and improve model training efficiency. In addition, the i^{th} node may train and update the allocated submodel by using forward propagation data and backward gradient data of another node. This expands a local dataset of the node to an extent, and helps improve a training effect of the global model.

The foregoing describes in detail the methods in embodiments of this application. The following provides apparatuses in embodiments of this application.

FIG. 19 is a diagram of a structure of a node 1900 for training a machine learning model in a distributed system according to an embodiment of this application. The distributed system includes a plurality of node groups, each node group includes a plurality of nodes, each node includes a submodel of the machine learning model, and submodels in the plurality of nodes in a same node group are sequentially cascaded to form the machine learning model. As shown in FIG. 19, each node includes a first transceiver unit 1901 and a first processing unit 1902.

A first transceiver unit 1901 of an i^{th} node in a first node group is configured to obtain second data based on first data and a submodel in the i^{th} node, where the first node group is any node group in the plurality of node groups, the i^{th} node is any node in the first node group, and the first data is local data of the i^{th} node or output data sent by an (i−1)^{th} node in the same node group.

A first processing unit 1902 of the i^{th} node is configured to perform gradient backpropagation based on third data, to obtain first gradient information of the i^{th} node, where the third data is output data sent by an (i+1)^{th} node in the same node group or local output data.

The first transceiver unit 1901 of the i^{th} node is further configured to receive a model parameter sent by at least one first node, where the first node is a node in a second node group, and the second node group is a node group other than the first node group.

The first processing unit 1902 of the i^{th} node is further configured to update a parameter of a local submodel based on the model parameter.

In a possible implementation, structure information of a submodel in the first node is the same as structure information of the submodel in the i^{th} node, or structure information of a submodel in the first node is different from structure information of the submodel in the i^{th} node.

The structure information includes one or more of the following: a network layer included in the submodel; and a layer index of the network layer that is included in the submodel and that is in the machine learning model.

In a possible implementation, nodes that store a same submodel in the plurality of node groups form a node cluster, each node cluster corresponds to a node cluster index, and the i^{th} node and the at least one first node correspond to a first node cluster index.

In a possible implementation, the at least one first node includes each node in at least one second node group.

In a possible implementation, each node group corresponds to a node group index, and a node in each node group has a corresponding node index; and the first transceiver unit 1901 of the i^{th} node is further configured to:
receive a node group index of the at least one second node group and a node index of a node in the at least one second node group.

The first processing unit 1902 of the i^{th} node is further configured to cascade, based on the received node group index and node index, a model parameter sent by the first node in each second node group, to obtain a parameter of each network layer of the machine learning model.

The first processing unit 1902 of the i^{th} node is specifically configured to:
obtain, from the parameter of each network layer, a parameter corresponding to a first-layer index, where the first-layer index is a layer index of a network layer that is included in the submodel in the i^{th} node and that is in the machine learning model; and
update the parameter of the local submodel based on the obtained parameter corresponding to the first-layer index and a parameter of a local model.

In a possible implementation, the at least one first node is determined based on a second-layer index sent by a node in each second node group, the second-layer index is a layer index of a network layer that is included in a submodel in the node in each second node group and that is in the machine learning model, a second-layer index of the at least one first node and a first-layer index include a same layer index, and the first-layer index is a layer index of a network layer that is included in the submodel in the i^{th} node and that is in the machine learning model.

In a possible implementation, the first processing unit 1902 of the i^{th} node is specifically configured to:
update the parameter of the local submodel based on the model parameter sent by the at least one first node and a parameter of a local model.

In a possible implementation, the first transceiver unit 1901 of the i^{th} node is specifically configured to:
receive, after a first moment, the model parameter sent by the at least one first node, where the first moment is a moment at which the plurality of node groups complete one or more rounds of local training.

It should be noted that, for implementations of the units described in FIG. 19, refer to corresponding descriptions in the embodiment shown in FIG. 4. In addition, for beneficial effects brought by the node described in FIG. 19, refer to corresponding descriptions in the embodiment shown in FIG. 4. Details are not described herein again.

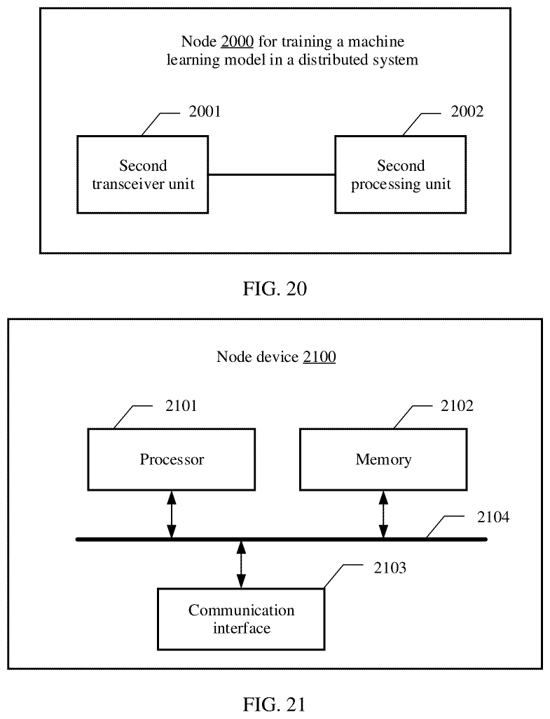

FIG. 20 is a diagram of a structure of another node 2000 for training a machine learning model in a distributed system according to an embodiment of this application. The distributed system includes a plurality of nodes, each node includes a submodel of the machine learning model, and submodels in at least two nodes are sequentially cascaded to form the machine learning model. As shown in FIG. 20, each node includes a second transceiver unit 2001 and a second processing unit 2002.

A second processing unit 2002 of an i^{th} node is configured to: obtain fifth data based on fourth data and a submodel in the i^{th} node, where the i^{th} node is any node in the plurality of nodes, the fourth data is local data of the i^{th} node or data sent by at least one third node, and the at least one third node and the i^{th} node are different nodes; and perform gradient backpropagation based on sixth data, to obtain second gradient information of the i^{th} node, where the sixth data is output data sent by at least one fourth node or local output data of the i^{th} node, and the at least one fourth node and the i^{th} node are different nodes.

In a possible implementation, submodels in the at least one third node have same structure information, and/or submodels in the at least one fourth node have same structure information.

The structure information includes one or more of the following: a network layer included in the submodel; and a layer index of the network layer that is included in the submodel and that is in the machine learning model.

In a possible implementation, the at least one third node forms a node cluster, and the node cluster corresponds to a node cluster index. A second transceiver unit 2001 of the i^{th} node is configured to receive the node cluster index sent by the at least one third node.

The second processing unit 2002 of the i^{th} node is further configured to receive, based on the node cluster index, the fourth data sent by the at least one third node.

In a possible implementation, the at least one fourth node forms a node cluster, and the node cluster corresponds to a node cluster index. The second transceiver unit 2001 of the i^{th} node is further configured to receive the node cluster index sent by the at least one fourth node.

The second processing unit 2002 of the i^{th} node is further configured to receive, based on the node cluster index, the sixth data sent by the at least one fourth node.

In a possible implementation, the second transceiver unit 2001 of the i^{th} node is further configured to receive a third-layer index sent by at least one fifth node, where the third-layer index is a layer index of a last layer that is of a submodel in each fifth node and that is in the machine learning model, and the at least one fifth node and the i^{th} node are different nodes.

The second processing unit 2002 of the i^{th} node is further configured to determine the at least one third node from the at least one fifth node based on the third-layer index, where the submodel in the i^{th} node includes a network layer corresponding to the third-layer index.

The second transceiver unit 2001 of the i^{th} node is further configured to receive the fourth data sent by the at least one third node.

In a possible implementation, the second transceiver unit 2001 of the i^{th} node is further configured to receive a fourth-layer index sent by at least one sixth node, where the fourth-layer index is a layer index of a first layer that is of a submodel in each sixth node and that is in the machine learning model, and the at least one sixth node and the i^{th} node are different nodes.

The second processing unit 2002 of the i^{th} node is further configured to determine the at least one fourth node from the at least one sixth node based on the fourth-layer index, where the submodel in the i^{th} node includes a network layer corresponding to the fourth-layer index.

The second transceiver unit 2001 of the i^{th} node receives the sixth data sent by the at least one fourth node.

In a possible implementation, the second processing unit 2002 of the i^{th} node is specifically configured to perform gradient backpropagation based on the sixth data after a second moment, where the second moment is a moment at which the plurality of nodes all complete forward propagation.

In a possible implementation, the distributed system includes a plurality of node groups, each node group includes the at least two nodes, and the plurality of nodes include nodes in the plurality of node groups; the i^{th} node is any node in any one of the plurality of node groups; the at least one third node includes an (i−1)^{th} node in a node group to which the i^{th} node belongs and/or at least one node in a node group other than the node group to which the i^{th} node belongs; and the at least one fourth node includes an (i+1)^{th} node in the node group to which the i^{th} node belongs and/or the at least one node in the node group other than the node group to which the i^{th} node belongs.

It should be noted that, for implementations of the units described in FIG. 20, refer to corresponding descriptions in the embodiment shown in FIG. 14. In addition, for beneficial effects brought by the node described in FIG. 20, refer to corresponding descriptions in the embodiment shown in FIG. 14. Details are not described herein again.

Based on the descriptions of the foregoing method embodiments and node embodiments, an embodiment of this application further provides a node device. FIG. 21 is a diagram of a structure of a node device 2100 according to an embodiment of this application. The node device 2100 includes a processor 2101, a memory 2102, and a communication interface 2103. The processor 2101, the memory 2102, and the communication interface 2103 are connected to each other through a bus 2104. The node device 2100 may be configured to perform related steps of a method for training a machine learning model in a distributed system. The node device 2100 may be a terminal device, a base station, a server, a cloud device, or the like. The processor 2101 in the node device 2100 is configured to read computer program code stored in the memory 2102, to perform the method in any embodiment shown in FIG. 4 or FIG. 14.

The memory 2102 includes but is not limited to a random access memory (RAM), a read-only memory (ROM), an erasable programmable read-only memory (EPROM), or a compact disc read-only memory (CD-ROM). The memory 2102 is configured to store a related computer program and data. The communication interface 2103 is configured to receive and send data.

The processor 2101 may be one or more central processing units (CPUs). When the processor 2101 is one CPU, the CPU may be a single-core CPU or a multi-core CPU.

In a possible implementation, the distributed system includes a plurality of node groups, each node group includes a plurality of node devices, each node device includes a submodel of the machine learning model, and submodels in the plurality of node devices in a same node group are sequentially cascaded to form the machine learning model. A processor 2101 in an i^{th} node device 2100 in a first node group is configured to read computer program code stored in the memory 2102, to perform the following operations:
obtaining second data based on first data and a submodel in the i^{th} node device 2100, where the first node group is any node group in the plurality of node groups, the i^{th} node device 2100 is any node device in the first node group, and the first data is local data of the i^{th} node device or output data sent by an (i−1)^{th} node device in the same node group;
performing gradient backpropagation based on third data, to obtain first gradient information output by the i^{th} node device 2100, where the third data is output data sent by an (i+1)^{th} node device in the same node group or local output data;
receiving, through the communication interface 2103, a model parameter sent by at least one first node device, where the first node device is a node device in a second node group, and the second node group is a node group other than the first node group; and updating a parameter of a local submodel based on the model parameter.

In another possible implementation, the distributed system includes a plurality of node devices, each node device includes a submodel of the machine learning model, and submodels in at least two node devices are sequentially cascaded to form the machine learning model. A processor 2101 in an i^{th} node device 2100 is further configured to read computer program code stored in the memory 2102, to perform the following operations:
obtaining fifth data based on fourth data and a submodel in the i^{th} node device 2100, where the i^{th} node device 2100 is any node device in the plurality of node devices, the fourth data is local data of the i^{th} node device or data sent by at least one third node device, and the at least one third node device and the i^{th} node device 2100 are different node devices; and performing gradient backpropagation based on sixth data, to obtain second gradient information output by the i^{th} node device 2100, where the sixth data is output data sent by at least one fourth node device or local output data of the i^{th} node device 2100, and the at least one fourth node device and the i^{th} node device 2100 are different node devices.

It should be noted that for implementations of operations of the node device 2100 described in FIG. 21, refer to corresponding descriptions in the embodiment shown in FIG. 4 or FIG. 14. In addition, for beneficial effects brought by the node device 2100 described in FIG. 21, refer to corresponding descriptions in the embodiment shown in FIG. 4 or FIG. 14. Details are not described herein again.

An embodiment of this application further provides a chip, including a processor, configured to call a computer program from a memory and run the computer program, so that a device on which the chip is mounted performs the method in any embodiment shown in FIG. 4 or FIG. 14.

An embodiment of this application further provides a computer-readable storage medium. The computer-readable storage medium stores a program and instructions that are executed by a device. When the program and the instructions are run on the device, the method procedure shown in FIG. 4 or FIG. 14 is implemented.

An embodiment of this application further provides a computer program product, including a computer program. When the computer program is run on a device, the method procedure shown in FIG. 4 or FIG. 14 is implemented.

It should be understood that, the processor mentioned in embodiments of this application may be a CPU or may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It should be further understood that the memory mentioned in embodiments of this application may be a volatile memory or a nonvolatile memory, or may include a volatile memory and a nonvolatile memory. The nonvolatile memory may be a ROM, a programmable read-only memory (PROM), an EPROM, an electrically erasable programmable read-only memory (EEPROM), or a flash memory. The volatile memory may be a RAM, and is used as an external cache. Through example but not limitative descriptions, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

It should be noted that when the processor is a general-purpose processor, a DSP, an ASIC, an FPGA or another programmable logic device, a discrete gate or transistor logic device, or a discrete hardware component, the memory (a storage module) is integrated into the processor.

It should be noted that the memory described in this specification aims to include but is not limited to these memories and any memory of another proper type.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

In the several embodiments provided in this application, it should be understood that the disclosed system, apparatus and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

In this application, “at least one” means one or more, and “a plurality of” means two or more. “And/or” describes an association relationship between associated objects, and represents that three relationships may exist. For example, A and/or B may represent the following cases: Only A exists, both A and B exist, and only B exists, where A and B may be singular or plural. In text descriptions of this application, the character “/” generally represents an “or” relationship between associated objects.

A sequence of the steps of the method in embodiments of this application may be adjusted, combined, or removed based on an actual requirement.

The modules in the apparatus in embodiments of this application may be combined, divided, and deleted based on an actual requirement.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

1. A method for training a machine learning model in a distributed system, wherein the distributed system comprises a plurality of node groups, each node group comprises a plurality of nodes, each node comprises a submodel of the machine learning model, and submodels in the plurality of nodes in a same node group are sequentially cascaded to form the machine learning model; and
the method comprises:
obtaining, by an i^{th} node in a first node group, second data based on first data and a submodel in the i^{th} node, wherein the first node group is a node group in the plurality of node groups, the i^{th} node is a node in the first node group, and the first data is local data of the i^{th} node or output data of an (i−1)^{th} node in the same node group;
performing, by the i^{th} node, gradient backpropagation based on third data, to obtain first gradient information of the i^{th} node, wherein the third data is output data of an (i+1)^{th} node in the same node group or local output data of the i^{th} node;
receiving, by the i^{th} node, a model parameter from at least one first node, wherein the at least one first node is a node in a second node group of the plurality of node groups, and the second node group is a node group other than the first node group; and
updating, by the i^{th} node, a parameter of a local submodel based on the model parameter.

2. The method according to claim 1, wherein structure information of a submodel in the at least one first node is the same as structure information of the submodel in the i^{th} node, or structure information of a submodel in the at least one first node is different from structure information of the submodel in the i^{th} node; and
the structure information comprises one or more of: a network layer comprised in the submodel; and a layer index of the network layer that is comprised in the submodel and that is in the machine learning model.

3. The method according to claim 1, wherein nodes that store a same submodel in the plurality of node groups form a node cluster, each node cluster corresponds to a node cluster index, and the i^{th} node and the at least one first node correspond to a first node cluster index, wherein the i^{th} node determines the at least one first node based on at least one node cluster index received from at least one second node in the second node group.

4. The method according to claim 2, wherein nodes that store a same submodel in the plurality of node groups form a node cluster, each node cluster corresponds to a node cluster index, and the i^{th} node and the at least one first node correspond to a first node cluster index, wherein the i^{th} node determines the at least one first node based on at least one node cluster index received from at least one second node in the second node group.

5. The method according to claim 2, wherein the at least one first node comprises each node in the second node group.

6. The method according to claim 5, wherein each node group corresponds to a node group index, and a node in each node group has a corresponding node index; and the method further comprises:
receiving, by the i^{th} node, a node group index of the second node group and a node index of a node in the second node group; and
cascading, by the i^{th} node based on the received node group index and the received node index, a model parameter sent by the at least one first node, to obtain a parameter of each network layer of the machine learning model,
wherein the updating, by the i^{th} node, the parameter of the local submodel based on the model parameter comprises:
obtaining, by the i^{th} node from the parameter of each network layer, a parameter corresponding to a first-layer index, wherein the first-layer index is a layer index of a network layer that is comprised in the submodel in the i^{th} node and that is in the machine learning model; and
updating, by the i^{th} node, the parameter of the local submodel based on the obtained parameter corresponding to the first-layer index and a parameter of a local model.

7. The method according to claim 2, wherein the at least one first node is determined based on a second-layer index from a node in the second node group, the second-layer index is a layer index of a network layer that is comprised in a submodel in the node in the second node group and that is in the machine learning model, a second-layer index of the at least one first node and a first-layer index comprise a same layer index, and the first-layer index is a layer index of a network layer that is comprised in the submodel in the i^{th} node and that is in the machine learning model.

8. The method according to claim 7, wherein updating, by the i^{th} node, the parameter of the local submodel based on the model parameter comprises:
updating, by the i^{th} node, the parameter of the local submodel based on the model parameter from the at least one first node and a parameter of a local model.

9. The method according to claim 1, wherein receiving, by the i^{th} node, the model parameter sent by the at least one first node comprises:
receiving, by the i^{th} node after a first moment, the model parameter sent by the at least one first node, wherein the first moment is a moment at which the plurality of node groups complete one or more rounds of local training.

10. The method according to claim 2, wherein receiving, by the i^{th} node, the model parameter sent by the at least one first node comprises:
receiving, by the i^{th} node after a first moment, the model parameter sent by the at least one first node, wherein the first moment is a moment at which the plurality of node groups complete one or more rounds of local training.

11. The method according to claim 3, wherein receiving, by the i^{th} node, the model parameter sent by the at least one first node comprises:
receiving, by the i^{th} node after a first moment, the model parameter sent by the at least one first node, wherein the first moment is a moment at which the plurality of node groups complete one or more rounds of local training.

12. A method for training a machine learning model in a distributed system, wherein the distributed system comprises a plurality of nodes, each node comprises a submodel of the machine learning model, and submodels in at least two nodes are sequentially cascaded to form the machine learning model; and
the method comprises:
obtaining, by an i^{th} node, second data based on first data and a submodel in the i^{th} node, wherein the i^{th} node is a node in the plurality of nodes, the first data is local data of the i^{th} node or data from at least one first node, and the at least one first node and the i^{th} node are different nodes; and
performing, by the i^{th} node, gradient backpropagation based on third data, to obtain first gradient information of the i^{th} node, wherein the third data is output data from at least one second node or local output data of the i^{th} node, and the at least one second node and the i^{th} node are different nodes.

13. The method according to claim 12, wherein at least one of the submodels in the at least one first node or submodels in the at least one second node have same structure information; and
the structure information comprises one or more of a network layer comprised in the submodel; and a layer index of the network layer that is comprised in the submodel and that is in the machine learning model.

14. The method according to claim 12, wherein the at least one first node forms a node cluster, and the node cluster corresponds to a node cluster index; and the method further comprises:
receiving, by the i^{th} node, the node cluster index from the at least one first node; and
receiving, by the i^{th} node based on the node cluster index, the first data sent by the at least one first node.

15. The method according to claim 12, wherein the at least one second node forms a node cluster, and the node cluster corresponds to a node cluster index; and the method further comprises:
receiving, by the i^{th} node, the node cluster index sent by the at least one second node; and
receiving, by the i^{th} node based on the node cluster index, the third data sent by the at least one second node.

16. The method according to claim 13, wherein the method further comprises:
receiving, by the i^{th} node, a first-layer index sent by at least one third node, wherein the first-layer index is a layer index of a last layer that is of a submodel in each third node and that is in the machine learning model, and the at least one third node and the i^{th} node are different nodes;
determining, by the i^{th} node, the at least one third node based on the first-layer index, wherein the submodel in the i^{th} node comprises a network layer corresponding to the first-layer index; and
receiving, by the i^{th} node, the first data sent by the at least one first node.

17. The method according to claim 13, wherein the method further comprises:
receiving, by the i^{th} node, a second-layer index sent by at least one fourth node, wherein the second-layer index is a layer index of a first layer that is of a submodel in each fourth node and that is in the machine learning model, and the at least one fourth node and the i^{th} node are different nodes;
determining, by the i^{th} node, the at least one second node from the at least one fourth node based on the second-layer index, wherein the submodel in the i^{th} node comprises a network layer corresponding to the second-layer index; and
receiving, by the i^{th} node, the third data sent by the at least one second node.

18. The method according to claim 12, wherein performing, by the i^{th} node, gradient backpropagation based on the third data comprises:
performing, by the i^{th} node, gradient backpropagation based on the third data after a first moment, wherein the first moment is a moment at which the plurality of nodes all complete forward propagation.

19. The method according to claim 12, wherein the distributed system comprises a plurality of node groups, each node group of the plurality of node groups comprises the at least two nodes, and the at least two nodes comprise nodes in the plurality of node groups; the i^{th} node is a node in a node group of the plurality of node groups; the at least one first node comprises at least one of an (i−1)^{th} node in a node group to which the i^{th} node belongs or at least one node in a node group other than the node group to which the i^{th} node belongs; and the at least one second node comprises at least one of an (i+1)^{th} node in the node group to which the i^{th} node belongs or the at least one node in the node group other than the node group to which the i^{th} node belongs.

20. A node device, comprising a processor, a memory, a communication interface, and one or more programs, wherein the one or more programs are stored in the memory, and when the one or more programs are configured to be executed by the processor, the one or more programs cooperate with the communication interface to implement operations comprising:
obtaining second data based on first data and a submodel in the node device, wherein the node device is a node in a first node group, the first node group is a node group in a plurality of node groups, and the first data is local data of the node device or output data of an (i−1)^{th} node in the same node group;
performing gradient backpropagation based on third data, to obtain first gradient information of the node device, wherein the third data is output data of an (i+1)^{th} node in the same node group or local output data;
receiving a model parameter from at least one first node, wherein the at least one first node is a node in a second node group of the plurality of node groups, and the second node group is a node group other than the first node group; and
updating a parameter of a local submodel based on the model parameter.
